(19) United States
(12) Patent Application Publication
(10) Pub. No.: US 2024/0196911 A1
(43) Pub. Date: Jun. 20, 2024

(54) BAKED GOOD COMPOSITIONS CONTAINING ALLULOSE

(71) Applicant: CORN PRODUCTS DEVELOPMENT, INC., Westchester, IL (US)

(72) Inventors: Claire IVERSON-BURT, Bridgewater, NJ (US); Didem ICOZ, Bridgewater, NJ (US); Matthew PARK, Bridgewater, NJ (US)

(21) Appl. No.: 17/768,355

(22) PCT Filed: Oct. 16, 2020
(86) PCT No.: PCT/US2020/056029

§ 371 Date: Apr. 12, 2022

Related U.S. Application Data
(60) Provisional application No. 62/924,669, filed on Oct. 22, 2019.

(51) Int. Cl. A21D 13/062; A21D 2/02; A21D 2/14; A21D 2/18

(52) U.S. Cl. CPC A21D 13/062; A21D 2/02; A21D 2/145; A21D 2/181

(57) ABSTRACT

Described herein are allulose-containing baked good compositions containing allulose and leavening acids and baked goods made therefrom, as well as methods of making such compositions and baked goods. wherein one or more allulose-containing composition described herein reduces the browning caused by allulose in the allulose-containing baked goods made therefrom. The allulose-containing baked goods described herein have reduced added sugars and reduced caloric content as a result of the allulose replacing at least a portion of the nutritive sweetener (e.g., sugar) contained in a full sugar sweet baked good while beneficially addressing the undesirable color, and/or flavor changes that can result from allulose inclusion and without negative effects to textural characteristics.

### CROSS-REFERENCE TO RELATED APPLICATION

This application claims the benefit of U.S. Provisional Patent Application No. 62/924,669, filed Oct. 22, 2019, which is hereby incorporated herein reference in its entirety.

Described herein are allulose-containing baked good compositions and allulose-containing baked goods made therefrom, as well as methods of making such compositions and baked goods. More specifically, allulose-containing baked good compositions described herein comprise allulose and leavening acids, wherein allulose-containing baked goods made with such compositions exhibit a reduction in the excessive browning caused by allulose. Also described herein are allulose-containing baked goods comprising one or more allulose-containing baked good composition described herein and a level of browning comparable to the level of browning achieved with a full sugar baked good composition. Beneficially, the allulose-containing baked good has reduced added sugars and reduced caloric content as a result of the allulose replacing at least a portion of the nutritive sweetener (e.g., sugar) contained in a full sugar baked good. The inclusion of leavening acids in the allulose-containing baked good compositions described herein overcomes the formulation challenges resulting from replacing at least a portion of the nutritive sweetener (e.g., sugar) contained in a full sugar baked good composition with allulose, such as greater development of brown colors and flavors. The leavening acids also unexpectedly reduce the browning reactions.

It is well known that nutritive sweeteners (such as, e.g., sucrose, glucose, fructose, corn syrup (including high fructose corn syrup), honey, agave and others) contribute to the caloric content of food, such as, e.g., baked goods. Natural and synthetic sweeteners (i.e., artificial sweeteners) are an alternative to nutritive sweeteners as they provide desirable taste characteristics as well as other functional properties with significantly lower caloric content. Such sweeteners can include high potency or high intensity sweeteners (such as, e.g., sucralose, stevia, etc.), sugar alcohols or polyols (such as, e.g., xylitol, sorbitol, etc.), rare sugars, and the like. Allulose is an example of a rare sugar, as it is found in nature in very small amounts, such as, e.g., in raisins and figs. Allulose is also referred to as D-allulose, psicose, or D-psicose and provides approximately 70% of the sweetness of sucrose with only 10% of the calories (approximately 0.4 kcal/g).

There is an ongoing preference in various food products, in particular sweet baked goods, to reduce intake of nutritive sweeteners, in order to provide both caloric and total/added sugar reduction. Accordingly, there has been an increase in the use of alternative sweeteners in food product compositions, including the compositions of sweet baked goods. Allulose is an example of a sweetener that has been formulated into various food and beverage products. For example, food products containing high levels of allulose have been made in an attempt to provide food products exhibiting the desired bulking, sweetening and functional properties traditionally provided by nutritive sweeteners. See, e.g., WO2015/075473. In bakery applications, allulose contributes to the Maillard browning reaction that is typical for sweet baked goods baked under high temperature baking conditions, producing a more browned color and flavor in comparison to sucrose.

A solution has not yet been identified for overcoming the changes in color, texture, and/or flavor of sweet baked goods associated with replacing nutritive sweeteners with allulose. US2016/032463 discloses that allulose-containing baked goods exhibit changes in physical properties that need to be optimized, including, e.g., crumb structure, level of browning, moisture retention, and the like. However, US2016/032463 does not provide a single solution for overcoming any of these physical property changes beyond possibly modifying the amounts of all of the ingredients and potentially the baking conditions. As a result, US2016/032463 merely provides allulose-containing reduced-sugar baked good compositions that fail to exhibit one or more of the physical properties consumers and food manufacturers desire in sweet baked goods made therefrom.

Accordingly, disclosed herein are allulose-containing baked good compositions, allulose-containing baked goods made from such compositions and methods of making the compositions and baked goods therefrom, wherein such compositions contain allulose in combination with leavening acids at usage levels that reduce the excessive browning commonly seen in sweet baked goods containing allulose (i.e. provides a sweet baked good with browning that is comparable to a full-sugar baked good). It is desirable to overcome the baking challenges attributed to allulose while attaining acceptable product quality (for instance, no negative off-notes etc.) and beneficially reducing sugar and calorie content as compared to a full sugar baked good made from a full sugar baked good composition.

One embodiment is directed to an allulose-containing baked good composition that overcomes the varying effects of allulose on brown colors and flavors, without negatively affecting the taste, structure and/or texture of the allulose-containing baked goods produced therefrom. In another embodiment, one or more allulose-containing baked good composition described herein comprises: from about 1 wt-% to about 25 wt-% allulose (dry basis); from about 0.3 wt-% to about 3 wt-% leavening acid, wherein the leavening acid is cream of tartar, citric acid, glucono delta-lactone, monocalcium phosphate, sodium acid pyrophosphate, sodium aluminum phosphate, or a mixture thereof; a nutritive sweetener at least partially replaced by the allulose; and a combination of at least three baking ingredients comprising flour, eggs and/or egg-derived products, milk and/or other dairy or non-dairy products, oil and/or fats. In yet another embodiment, one or more allulose-containing baked good comprising one or more allulose-containing baked good composition described herein has comparable browning to a full sugar baked good comprising a composition containing a nutritive sweetener as measured by (i) L color measurement having a “Delta L” with a minimum of −13, wherein “L” represents a change in color from black to white; (ii) “a” and/or “b” color measurements having at least one of a “Delta a” with a maximum of +6.5 and/or a “Delta b” with a maximum of +2.5, wherein the “Delta” measurement is the sample value minus a full sugar control value, and wherein “a” represents a change in color from green to red, and “b” represents a change in color from blue to yellow; or (iii) a combination of (i) and (ii).

Still a further embodiment is directed to using one or more allulose-containing baked good composition described herein to produce an allulose-containing baked good having comparable browning to a full-sugar baked good comprising a composition containing a nutritive sweetener.

An even still further embodiment is directed to a method for reducing the browning of a an allulose-containing baked good comprising: (i) replacing at least a portion of a nutritive sweetener in a baked good composition with allulose; (ii) adding one or more leavening acid selected from cream of tartar, citric acid, glucono delta-lactone, monocalcium phosphate, sodium acid pyrophosphate and sodium aluminum phosphate to the composition; baking the composition; and obtaining the allulose-containing baked good. In an event further embodiment, the one or more method described herein produces an allulose-containing baked good having comparable browning to a full sugar baked good comprising a composition containing a nutritive sweetener as measured by (i) L color measurement having a “Delta L” with a minimum of −13, wherein “L” represents a change in color from black to white; (ii) “a” and/or “b” color measurements having at least one of a “Delta a” with a maximum of +6.5 and/or a “Delta b” with a maximum of +2.5, wherein the “Delta” measurement is the sample value minus a full sugar control value, and wherein “a” represents a change in color from green to red, and “b” represents a change in color from blue to yellow; or (iii) a combination of (i) and (ii).

Still another embodiment is directed to a food ingredient system comprising allulose and one or more leavening acid selected from cream of tartar, citric acid, glucono delta-lactone, monocalcium phosphate, sodium acid pyrophosphate, and sodium aluminum phosphate. In still further embodiments, one or more food ingredient system described herein further comprises a nutritive, partially-nutritive and/or non-nutritive sweetener.

Various embodiments of the present invention will be described in detail with reference to the drawings, wherein like reference numerals represent like parts throughout the several views. And while multiple embodiments are disclosed herein, still other embodiments will become apparent to those skilled in the art from the following detailed description, which shows and describes illustrative embodiments. As a result, reference to various embodiments does not limit the scope of the invention. Additionally, the figures represented herein are not limitations to the various embodiments according to the invention and are presented for exemplary illustration of the invention. Accordingly, the drawings and detailed description are to be regarded as illustrative in nature and not restrictive.

### BRIEF DESCRIPTION OF THE DRAWINGS

FIGS. 1A-1E show photographs of finished cake cross-sections containing cream of tartar in Control (FIG. 1A), Negative Control (FIG. 1B), and at levels above the ranges in the controls, including 0.85% (FIG. 1C), 1.2% (FIG. 1D), and 1.8% (FIG. 1E).

FIGS. 2A-2D show photographs of finished cake cross-sections of the Control (FIG. 2A), Negative Control (FIG. 2B), and those with 0.57% citric acid with original baking soda amount (0.69%) (FIG. 2C) and with a higher level of baking soda (1.00%) (FIG. 2D).

FIGS. 3A-3D show photographs of finished cake cross-sections of the Control (FIG. 3A), Negative Control (FIG. 3B), and those containing Glucono delta-lactone in amounts of 0.31% (FIG. 3C), 0.85% (FIG. 3D), 1.2% (FIG. 3E), and 1.8% (FIG. 3C).

FIGS. 4A-4E shows photographs of finished cake cross-sections of the Control (FIG. 4A), Negative Control (FIG. 4B), and those containing citric acid and increased level of baking soda (FIG. 4C), cream of tartar (FIG. 4D) and with glucono-delta lactone (FIG. 4E).

FIG. 5 shows a graph of the averaged crust and crumb L* a* b* values as a measurement of color as evaluated in Example 4.

FIG. 6 shows a graph of the average cake heights as evaluated in Example 4.

FIG. 7 shows a graph of the average cake moisture as evaluated in Example 4.

FIG. 8 shows a graph of the average cake water activity as evaluated in Example 4.

FIGS. 9A-9E show photographs of finished cake cross-sections containing cream of tartar in Control (FIG. 9A), Negative Control (FIG. 9B), and at levels above the ranges in the controls, including 0.85% (FIG. 9C), 1.2% (FIG. 9D), and 1.8% (FIG. 9E) as evaluated in Example 5.

FIG. 10 shows the average values of L* a* b* in Table 13 graphically as evaluated in Example 5.

FIG. 11 shows a graph of the average cake heights as evaluated in Example 5.

FIG. 12 shows a graph of the average cake moisture as evaluated in Example 5.

FIG. 13 shows a graph of the average cake water activity as evaluated in Example 5.

FIGS. 14A-14E show photographs of finished cake cross-sections of the Control (FIG. 14A), Negative Control (FIG. 14B), and those containing glucono delta-lactone in amounts of 0.85% (FIG. 14C) 1.2% (FIG. 14D), and 1.8% (FIG. 14E) as evaluated in Example 6.

FIG. 15 shows the average values of L* a* b* in Table 16 graphically as evaluated in Example 6.

FIG. 16 shows a graph of the average cake heights as evaluated in Example 6.

FIG. 17 shows a graph of the average cake moisture as evaluated in Example 6.

FIG. 18 shows a graph of the average cake water activity as evaluated in Example 6.

FIG. 19 shows a photograph of finished cake cross-sections containing various leavening acids compared to Control and Negative Control as evaluated in Example 7.

FIGS. 20A-20C show photographs of finished cake cross-sections of the Control (FIG. 20), Negative Control (FIG. 20B), and the cake containing the monocalcium phosphate (FIG. 20C) as evaluated in Example 8.

FIGS. 21A-21E show photographs of finished cake cross-sections of the Control (FIG. 21A), Negative Control (FIG. 21B), and those containing sodium acid pyrophosphate in amounts of 0.85% (FIG. 21C) 1.2% (FIG. 21D), and 1.8% (FIG. 21E) as evaluated in Example 9.

FIG. 22 shows the average values of L* a* b* in Table 28 graphically as evaluated in Example 9.

FIG. 23 shows a graph of the average cake heights as evaluated in Example 9.

FIG. 24 shows a graph of the average cake moisture as evaluated in Example 9.

FIG. 25 shows a graph of the average cake water activity as evaluated in Example 9.

FIGS. 26A-26E show photographs of finished cake cross-sections of the Control (FIG. 26A), Negative Control (FIG. 26B), and those containing sodium aluminum phosphate in amounts of 0.85% (FIG. 26C) 1.2% (FIG. 26D), and 1.8% (FIG. 26E) as evaluated in Example 10.

FIG. 27 shows the average values of L* a* b* in Table 35 graphically as evaluated in Example 10.

FIG. 28 shows a graph of the average cake heights as evaluated in Example 10.

FIG. 29 shows a graph of the average cake moisture as evaluated in Example 10.

FIG. 30 shows a graph of the average cake water activity as evaluated in Example 10.

All terminology used herein is for the purpose of describing particular embodiments only, and is not intended to be limiting in any manner or scope. For example, as used in this specification and the appended claims, the singular forms “a,” “an” and “the” can include plurals unless the context clearly indicates otherwise. Further, all units, prefixes, and symbols may be denoted in its SI accepted form. Numeric ranges recited within the specification are inclusive of the numbers within the defined range. Throughout this disclosure, various aspects are presented in a range format. It should be understood that the description in range format is merely for convenience and brevity and should not be construed as an inflexible limitation on the scope of the invention. Accordingly, the description of a range should be considered to have specifically disclosed all the possible sub-ranges as well as individual numerical values within that range (e.g., 1 to 5 includes 1, 1.5, 2, 2.75, 3, 3.80, 4, and 5).

To more readily understand the embodiments described herein, certain terms are first defined as set out hereinbelow. Unless defined otherwise, all technical and scientific terms used herein have the same meaning as commonly understood by one of ordinary skill in the art to which the embodiments of the invention pertain. Many methods and materials similar, modified, or equivalent to those described herein can be used in the practice of the embodiments without undue experimentation.

The term “about,” as used herein, refers to variations in the numerical quantity that can occur, for example, through typical measuring and handling procedures; through inadvertent error in these procedures; through differences in the manufacture, source, or purity of the ingredients; and the like. Whether or not modified by the term “about”, the claims include equivalents to the quantities.

The term “weight percent,” “wt-%,” “percent by weight,” “% by weight,” and variations thereof, as used herein, refer to the concentration of a substance as the weight of that substance divided by the total weight of the composition and multiplied by 100. It is understood that, as used here, “percent,” “%,” and the like are intended to be synonymous with “weight percent,” “wt-%,” etc.

The methods and compositions may comprise, consist essentially of, or consist of the components and ingredients as well as other ingredients described herein. As used herein, “consisting essentially of” means that the methods and compositions may include additional steps, components or ingredients, but only if the additional steps, components or ingredients do not materially alter the basic and novel characteristics of the claimed methods and compositions.

### Allulose-Containing Baked Good Compositions

Described herein is one or more allulose-containing baked good composition comprising allulose as a complete or partial replacement for a nutritive sweetener, including sucrose. One embodiment is directed to an allulose-containing baked good composition comprising allulose; one or more leavening acid selected from cream of tartar, citric acid, glucono delta-lactone, monocalcium phosphate, sodium acid pyrophosphate, and sodium aluminum phosphate; a nutritive sweetener at least partially replaced by the allulose; and a combination of at least three baking ingredients comprising flour, eggs and/or egg derived products, milk and/or other dairy or non-dairy products, oil and/or fats. Exemplary allulose-containing baked good compositions are shown in Tables 1A-1G.

TABLE 1A
Exemplary Allulose-containing Baked Good Compositions

| | First | Second | Third |
|---|---|---|---|
| | Exemplary | Exemplary | Exemplary |
| | Range | Range | Range |
| Material | wt-% | wt-% | wt-% |
| Allulose | 1-50 | 1-20 | 5-15 |
| Leavening Acid | 0.3-3 | 0.8-3 | 0.8-2 |
| Nutritive Sweetener | 0-40 | 1-30 | 5-20 |
| Baking Ingredients (e.g. Flour, | 30-70 | 40-70 | 45-60 |
| Eggs, Milk, Oils and/or Fats) | | | |
| Optional Additional Ingredients | 0-30 | 0-20 | 0-10 |

TABLE 1B
Exemplary Allulose-containing Baked Good
Compositions Containing Cream of Tartar

| | First | Second | Third |
|---|---|---|---|
| | Exemplary | Exemplary | Exemplary |
| | Range | Range | Range |
| Material | wt-% | wt-% | wt-% |
| Allulose | 1-50 | 1-20 | 5-15 |
| Cream of Tartar | 0.5-2.5 | 0.8-1.8 | 1-1.8 |
| Baking Soda | 0-1 | 0-0.8 | 0.5-0.8 |
| Nutritive Sweetener | 0-40 | 1-30 | 5-20 |
| Baking Ingredients (e.g. Flour, | 30-70 | 40-70 | 45-60 |
| Eggs, Milk, Oils and/or Fats) | | | |
| Optional Additional Ingredients | 0-30 | 0-20 | 0-10 |

TABLE 1C
Exemplary Allulose-containing Baked Good
Compositions Containing Citric Acid

| | First | Second | Third |
|---|---|---|---|
| | Exemplary | Exemplary | Exemplary |
| | Range | Range | Range |
| Material | wt-% | wt-% | wt-% |
| Allulose | 1-50 | 1-20 | 5-15 |
| Citric Acid | 0.3-2 | 0.5-2 | 0.5-1 |
| Baking Soda | 0-2 | 1-2 | 1-1.5 |
| Nutritive Sweetener | 0-40 | 1-30 | 5-20 |
| Baking Ingredients (e.g. Flour, | 30-70 | 40-70 | 45-60 |
| Eggs, Milk, Oils and/or Fats) | | | |
| Optional Additional Ingredients | 0-30 | 0-20 | 0-10 |

TABLE 1D
Exemplary Allulose-containing Baked Good Compositions
Containing Glucono Delta-Lactone

| | First | Second | Third |
|---|---|---|---|
| | Exemplary | Exemplary | Exemplary |
| | Range | Range | Range |
| Material | wt-% | wt-% | wt-% |
| Allulose | 1-50 | 1-20 | 5-15 |
| Glucono Delta-Lactone | 0.3-1.8 | 0.8-1.8 | 1-1.8 |
| Baking Soda | 0-1 | 0-50.8 | 0.5-0.8 |
| Nutritive Sweetener | 0-40 | 1-30 | 5-20 |
| Baking Ingredients (e.g. Flour, | 30-70 | 40-70 | 45-60 |
| Eggs, Milk, Oils and/or Fats) | | | |
| Optional Additional Ingredients | 0-30 | 0-20 | 0-10 |

TABLE 1E
Exemplary Allulose-containing Baked Good Compositions
Containing Monocalcium Phosphate

| | First | Second | Third |
|---|---|---|---|
| | Exemplary | Exemplary | Exemplary |
| | Range | Range | Range |
| Material | wt-% | wt-% | wt-% |
| Allulose | 1-50 | 1-20 | 5-15 |
| Monocalcium Phosphate | 0.31-0.85 | 0.31-0.75 | 0.31-0.5 |
| Baking Soda | 0-1 | 0-50.8 | 0.5-0.8 |
| Nutritive Sweetener | 0-40 | 1-30 | 5-20 |
| Baking Ingredients (e.g. Flour, | 30-70 | 40-70 | 45-60 |
| Eggs, Milk, Oils and/or Fats) | | | |
| Optional Additional Ingredients | 0-30 | 0-20 | 0-10 |

TABLE 1F
Exemplary Allulose-containing Baked Good Compositions
Containing Sodium Acid Pyrophosphate

| | First | Second | Third |
|---|---|---|---|
| | Exemplary | Exemplary | Exemplary |
| | Range | Range | Range |
| Material | wt-% | wt-% | wt-% |
| Allulose | 1-50 | 1-20 | 5-15 |
| Sodium Acid Pyrophosphate | 0.30-1.8 | 0.3-1.8 | 0.85-1.8 |
| Baking Soda | 0-1 | 0-50.8 | 0.5-0.8 |
| Nutritive Sweetener | 0-40 | 1-30 | 5-20 |
| Baking Ingredients (e.g. Flour, | 30-70 | 40-70 | 45-60 |
| Eggs, Milk, Oils and/or Fats) | | | |
| Optional Additional Ingredients | 0-30 | 0-20 | 0-10 |

TABLE 1G
Exemplary Allulose-containing Baked Good Compositions
Containing Sodium Aluminum Phosphate

| | First | Second | Third |
|---|---|---|---|
| | Exemplary | Exemplary | Exemplary |
| | Range | Range | Range |
| Material | wt-% | wt-% | wt-% |
| Allulose | 1-50 | 1-20 | 5-15 |
| Sodium Aluminum Phosphate | 0.30-1.8 | 0.3-1.8 | 0.85-1.8 |
| Baking Soda | 0-1 | 0-50.8 | 0.5-0.8 |
| Nutritive Sweetener | 0-40 | 1-30 | 5-20 |
| Baking Ingredients (e.g. Flour, | 30-70 | 40-70 | 45-60 |
| Eggs, Milk, Oils and/or Fats) | | | |
| Optional Additional Ingredients | 0-30 | 0-20 | 0-10 |

In some embodiments, the allulose replaces at least a portion of the nutritive sweetener contained in a full-sugar baked good composition, such that the amount of nutritive sweetener contained therein is reduced by at least about 5%, 10%, 20%, 30%, 40%, 50%, 55%, 60%, 65%, 70%, 75%, 80%, 85%, 90%, 95%, or 100%. In other embodiments, the allulose replaces or substantially reduces the amount of nutritive sweetener, e.g., sucrose, glucose, fructose, corn syrup, high fructose corn syrup, etc., contained in a full-sugar baked good composition, such that the amount of nutritive sweetener contained therein is reduced by at least about 5%, 10%, 20%, 30%, 40%, 50%, 55%, 60%, 65%, 70%, 75%, 80%, 85%, 90%, 95%, or 100%. Exemplary nutritive sweeteners include, but are not limited to, for example, sucrose, glucose, fructose, high fructose corn syrup, dextrose, various DE corn syrups, beet or cane sugar, molasses, maltose, honey, and maple sugar.

The golden brown color and brown flavor that occurs in baked goods, including but not limited to cakes, cookies, bread and such, upon baking is a result of Maillard browning. Maillard browning, also known as non-enzymatic browning, is the chemical reaction between the reactive carbonyl group of reducing sugars and nucleophilic amino group of the amino acids in the presence of heat. Higher pH conditions (basic) enhance the Maillard browning as the amino groups are deprotonated making them more available to react with reducing sugars. Likewise, lower pH (acidic) conditions reduce this reaction. Without being limited by a particular mechanism of action, combining allulose and one or more leavening acid in the allulose-containing baked good compositions described herein reduces the excessive browning in allulose-containing baked goods made therefrom in comparison to an allulose-containing baked good that is not made with one or more allulose-containing baked good composition described herein.

The reduction in excessive browning of an allulose-containing baked good comprising an allulose-containing baked good composition described herein can be measured by color quantification to assess whether the an allulose-containing baked good has comparable browning to a full sugar baked good comprising a baked good composition containing a nutritive sweetener. In one embodiment, the color measurements of “a” and/or “b” are compared to a full sugar control baked good through measurement of a Delta value, namely at least one of a “Delta a” with a maximum of +6.5 and/or a “Delta b” with a maximum of +2.5, or preferably a maximum of +1.5, wherein the “Delta” measurement is the sample value minus a full sugar control value, and wherein “a” represents a change in color from green to red, and “b” represents a change in color from blue to yellow. In another embodiment, the allulose-containing baked good comprising an allulose-containing baked good composition described herein has comparable browning to a full sugar baked good comprising a baked good composition containing a nutritive sweetener as further measured by L color measurement having a “Delta L” with a minimum of −13, or −11, or −10, wherein “L” represents a change in color from black to white.

In additional embodiments, one or more allulose-containing baked good compositions described herein and the allulose-containing baked goods produced therefrom beneficially have at least a 10% reduction in sugar content by replacing at least a portion of the nutritive sweetener contained in a full sugar baked good composition and/or the full sugar baked goods produced therefrom with allulose. In yet additional embodiments, the allulose-containing baked good compositions described herein and the allulose-containing baked goods produced therefrom beneficially have at least a 20%, 25%, 30%, 35%, 40%, 45%, 50%, 55%, 60%, 65%, 70%, 75%, 80%, 85%, 90%, 95%, or 100% reduction in the sugar content contained in a full sugar baked good composition and/or the full sugar baked goods produced therefrom.

In further embodiments, one or more allulose-containing baked good compositions described herein and the allulose-containing baked goods produced therefrom beneficially have a reduced caloric content by the replacement of at least a portion of the nutritive sweetener contained in a full sugar baked good composition and/or full sugar baked goods produced therefrom with allulose. In additional embodiments, one or more allulose-containing baked good compositions described herein and the allulose-containing baked goods produced therefrom beneficially have at least a 1%, 5%, 10%, 15%, 20%, 25%, 30%, 35%, 40%, 45%, or at least 50% reduction in caloric content by the replacement of the nutritive sweeteners contained in a full sugar baked good composition and/or full sugar baked goods produced therefrom with allulose.

### Allulose

One embodiment is directed to an allulose-containing baked good composition, such as, for example, a cake or cookie composition, comprising allulose. Allulose is a commercially-available monosaccharide having the following structure, which is a C3 epimer of D-fructose:

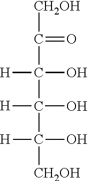 [SMILES: O=C(CO)C(O)C(O)C(O)CO]

Allulose is available in crystalline form or in the form of a syrup comprising allulose. In one embodiment, the syrup form comprises allulose in varying amounts of percent solids (generally between about 60% to about 90% by weight).

An exemplary allulose source is available under the tradename ASTRAEA® Liquid Allulose, with 95% purity (dry solids basis, ds or DS) and at 74% solids. Additional allulose sources may have a purity (expressed as weight % allulose, based on the total weight of the allulose source) of at least 80%, at least 85%, at least 90%, at least 95%, at least 96%, at least 97%, at least 98%, at least 99%, or at least 99.9%, or 100% pure allulose. Additional allulose sources may have a percent solids of at least about 65%, at least about 70%, at least about 75%, or greater.

In some embodiments, the allulose is a mixture of allulose and additional monosaccharides and disaccharides, determined according to the purity level of the allulose. In some embodiments, the allulose is an admixture of allulose and one or more other sugars, such as fructose. In other embodiments, the allulose is a syrup comprising from about 85 wt-% to about 95 wt-% allulose and from about 5 wt-% to about 15 wt-% of monosaccharides and disaccharides, based on the dry matter content of the syrup.

In some embodiments, the allulose is suitable for use as a single ingredient to replace the nutritive sweetener (e.g. sucrose) (either partial or complete replacement) contained in a full sugar baked good composition and/or the full sugar baked goods made therefrom. In some embodiments, allulose replaces 90% to 100% of the nutritive sweetener contained in a full sugar baked good composition and/or full sugar baked goods made therefrom such that no nutritive sweetener remains in the allulose-containing baked good composition and/or allulose containing baked good made therefrom, which beneficially reduces the sugar and/or caloric content of the allulose-containing baked good composition and/or allulose containing baked good made therefrom over the full sugar baked good composition and/or full sugar baked goods made therefrom.

In a further embodiment, the allulose comprises from about 1 wt-% to about 50 wt-% of the allulose-containing baked good composition, from about 5 wt-% to about 50 wt-% of the allulose-containing baked good composition, from about 5 wt-% to about 20 wt-% of the allulose-containing baked good composition, from about 5 wt-% to about 15 wt-% of the allulose-containing baked good composition, or from about 10 wt-% to about 15 wt-% of the allulose-containing baked good composition.

In a further embodiment, the allulose comprises on a dry basis from about 1 wt-% to about 50 wt-% of the allulose-containing baked good composition, from about 2 wt-% to about 20 wt-% of the allulose-containing baked good composition, from about 2 wt-% to about 15 wt-% of the allulose-containing baked good composition, or from about 5 wt-% to about 10 wt-% of the allulose-containing baked good composition.

### Leavening Acid

In a further embodiment, the one or more allulose-containing baked good compositions described herein further comprises a leavening acid. Leavening acids are combined with the allulose to overcome the browning reaction caused by the allulose, which is predominantly a monosaccharide and acts as a reducing sugar. In some embodiments, the leavening acid is selected from cream of tartar, citric acid, other food acids, glucono delta-lactone, monocalcium phosphate, sodium acid pyrophosphate, sodium aluminum phosphate, and mixtures thereof. In other embodiments, the leavening acid is selected from cream of tartar, citric acid, glucono delta-lactone, monocalcium phosphate, sodium acid pyrophosphate, sodium aluminum phosphate, and mixtures thereof. In still further embodiments, the leavening acid comprises from about 0.3 wt-% to about 3 wt-% of the allulose-containing baked good composition, from about 0.5 wt-% to about 3 wt-% of the allulose-containing baked good composition, from about 0.8 wt-% to about 3 wt-% of the allulose-containing baked good composition, or from about 0.8 wt-% to about 2 wt-% of the allulose-containing baked good composition.

In one embodiment, the one or more allulose-containing baked good compositions described herein further comprise cream of tartar as the leavening acid. Cream of tartar is a commonly used leavening agent that is a crystalline acidic compound, and also known as tartaric acid or potassium bitartrate (or potassium hydrogen tartrate). When the one or more allulose-containing baked good compositions described herein comprises cream of tartar as the leavening acid, it is included at an increased wt-% compared to both full sugar baked good compositions and the one or more allulose-containing baked good compositions described herein to reduce the excessive browning that the allulose causes in the allulose-containing baked good made from the one or more allulose-containing baked good compositions described herein. In some embodiments, the cream of tartar comprises from about 0.5 wt-% to about 2.5 wt-% of the allulose-containing baked good composition, from about 0.85 wt-% to about 1.8 wt-% of the allulose-containing baked good composition, from about 0.9 wt-% to about 1.8 wt-% of the allulose-containing baked good composition, or from about 1 wt-% to about 1.8 wt-% of the allulose-containing baked good composition.

In still other embodiments, the one or more allulose-containing baked good compositions described herein further comprise citric acid as the leavening acid. In yet other embodiments, the citric acid comprises from about 0.3 wt-% to about 2 wt-% of the allulose-containing baked good composition, from about 0.5 wt-% to about 2 wt-% of the allulose-containing baked good composition, or from about 0.5 wt-% to about 1 wt-% of the allulose-containing baked good composition.

In still other embodiments, the one or more allulose-containing baked good compositions described herein further comprise citric acid and baking soda as the leavening agent. Yet still other embodiments are directed to an allulose-containing baked good comprising an allulose-containing baked good composition described herein that further comprises citric acid and baking soda as the leavening agent, wherein the allulose-containing baked good has comparable texture to a full sugar baked good. In even further embodiments, the one or more allulose-containing baked good compositions described herein further comprise citric acid and baking soda as the leavening agent, wherein the amount of baking soda ranges from about 0 wt-% to about 2 wt-% of the allulose-containing baked good composition, from about 1 wt-% to about 2 wt-% of the allulose-containing baked good composition, or from about 1 wt-% to about 1.5 wt-% of the allulose-containing baked good composition.

In another embodiment, the one or more allulose-containing baked good compositions described herein further comprise glucono delta-lactone as the leavening acid. Glucono delta-lactone is also known as gluconolactone as it is a lactone of D-gluconic acid and is a crystalline powder. In some embodiments, the glucono delta-lactone comprises from about 0.3 wt-% to about 1.8 wt-% of the allulose-containing baked good composition, from about 0.85 wt-% to about 1.8 wt-% of the allulose-containing baked good composition, or from about 1 wt-% to about 1.8 wt-% of the allulose-containing baked good composition.

In still other embodiments, the one or more allulose-containing baked good compositions described herein further comprise additional food acids as the leavening acid. In yet other embodiments, the additional food acids are selected from Dicalcium Phosphate Dehydrate (DCPD), Sodium Acid Pyrophosphate (SAPP), Monocalcium Phosphate Monohydrate (MCP), Anhydrous Monocalcium Phosphate (AMCP), Sodium Aluminum Phosphate (SALP), Sodium Aluminum Sulfate (SAS), and mixtures thereof. In embodiments where the one or more allulose-containing baked good compositions comprise Monocalcium Phosphate Monohydrate as the leavening acid it is included in an amount comprising from about 0.31 wt-% to less than about 0.85 wt-% of the allulose-containing baked good composition, or from about 0.31 wt-% to less than about 0.5 wt-% of the allulose-containing baked good composition. In embodiments where the one or more allulose-containing baked good compositions comprise Sodium Acid Pyrophosphate as the leavening acid it is included in an amount comprising from about 0.3 wt-% to about 1.8 wt-% of the allulose-containing baked good composition, or from about 0.85 wt-% to about 1.8 wt-% of the allulose-containing baked good composition. In embodiments where the one or more allulose-containing baked good compositions comprise Sodium Aluminum Phosphate as the leavening acid it is included in an amount comprising from about 0.3 wt-% to about 1.8 wt-% of the allulose-containing baked good composition, or from about 0.85 wt-% to about 1.8 wt-% of the allulose-containing baked good composition.

### Nutritive and Partially Nutritive Sweeteners

In some embodiments, one or more allulose-containing baked good compositions described herein further comprise a nutritive sweetener (e.g., sucrose) (and/or a partially nutritive sweetener), wherein (i) at least a portion of the nutritive sweetener (and/or the partially nutritive sweetener) contained in the full sugar baked good composition is replaced by allulose, or (ii) the allulose at least partially replaces the nutritive sweetener (and/or the partially nutritive sweetener) contained in the full sugar baked good composition.

In some embodiments, the nutritive sweetener is selected from sucrose, cane sugar, fructose, glucose, glucose-fructose syrup, maple syrup, honey, molasses, erythritol, maltitol, lactitol, sorbitol, mannitol, xylitol, leucrose, trehalose, galactose, rhamnose, cyclodextrin (e.g., a-cyclodextrin, P-cyclodextrin, and y-cyclodextrin), ribulose, threose, arabinose, xylose, lyxose, allose, altrose, mannose, idose, lactose, maltose, invert sugar, isotrehalose, neotrehalose, palatinose or isomaltulose, erythrose, deoxyribose, gulose, idose, talose, erythrulose, xylulose, psicose, turanose, cellobiose, glucosamine, mannosamine, fucose, fuculose, glucuronic acid, gluconic acid, glucono-lactone, abequose, galactosamine, xylo-oligosaccharides (xylotriose, xylobiose and the like), gentio-oligoscaccharides (gentiobiose, gentiotriose, gentiotetraose and the like), galacto-oligosaccharides, sorbose, ketotriose (dehydroxyacetone), aldotriose (glyceraldehyde), nigero-oligosaccharides, fructooligosaccharides (kestose, nystose and the like), maltotetraose, maltotriol, tetrasaccharides, mannan-oligosaccharides, malto-oligosaccharides (maltotriose, maltotetraose, maltopentaose, maltohexaose, maltoheptaose and the like), dextrine, lactulose, melibiose, rhamnose, ribose, isomerized liquid sugars such as high fructose corn/starch syrup (HFCS/HFSS) (e.g., HFCS55, HFCS42, or HFCS90), coupling sugars, soybean oligosaccharides, glucose syrup, and combinations of any of the foregoing.

In other embodiments, the partially-nutritive sweetener (i.e. low calorie sweeteners) is a polyol. The term “polyol”, as used herein, refers to a molecule that contains more than one hydroxyl group. A polyol may be a diol, triol, or a tetraol, which contain 2, 3, or 4 hydroxyl groups, respectively. A polyol also may contain more than 4 hydroxyl groups, such as a pentaol, hexaol, heptaol, or the like, which contain 5, 6, or 7 hydroxyl groups, respectively. Additionally, a polyol also may be a sugar alcohol, polyhydric alcohol, or polyalcohol, which is a reduced form of carbohydrate, wherein the carbonyl group (aldehyde or ketone, reducing sugar) has been reduced to a primary or secondary hydroxyl group. In some embodiments, the polyol is selected from erythritol, maltitol, mannitol, sorbitol, lactitol, xylitol, isomalt, propylene glycol, glycerol (glycerin), threitol, galactitol, palatinose, reduced isomalto-oligosaccharides, reduced xylo-oligosaccharides, reduced gentio-oligosaccharides, reduced maltose syrup, reduced glucose syrup, sugar alcohols, any other carbohydrate capable of being reduced that does not adversely affect the taste of the sweetened compositions, and mixtures thereof. In yet other embodiments, the partially-nutritive sweetener is D-tagatose.

In still other embodiments, the one or more allulose-containing baked good compositions described herein further comprise the nutritive and/or partially nutritive sweetener in amounts of from about 0 wt-% to about 40 wt-%, from about 1 wt-% to about 35 wt-%, from about 1 wt-% to about 30 wt-%, from about 1 wt-% to about 25 wt-%, from about 1 wt-% to about 20 wt-%, from about 5 wt-% to about 20 wt-%, from about 5 wt-% to about 15 wt-%, or from about 10 wt-% to about 15 wt-% of the allulose-containing baked good composition.

In still other embodiments, the nutritive sweetener contained in a full sugar baked good composition is at least partially—to fully—replaced with allulose in one or more of the allulose-containing baked good compositions described herein.

### Baking Ingredients

In further embodiments, the allulose-containing baked good compositions described herein further comprise one or more baking ingredient, such as, for example, flour and/or other starch, eggs, milk, oil and/or fats. In some embodiments, one or more of the allulose-containing baked good compositions described herein further comprises at least three baking ingredients selected from flour, eggs, egg-derived products, milk, other dairy or non-dairy products, oil and fats.

In an exemplary embodiment, flours include those obtained from grinding grains, beans, roots, nuts, and/or seeds. Wheat flour is most commonly used in baking and can include all-purpose, self-rising, cake, and/or bleached flour. Other types of flours include corn, rye, and other cereal flours containing high proportions of starches.

In an exemplary embodiment, eggs and/or egg derived products include whole eggs, egg whites, egg yolks, pasteurized liquid eggs, and the like.

In an exemplary embodiment, milk and/or other dairy or non-dairy products include for example, cream (e.g. heavy cream), whole milk, reduced fat milk, non-fat milk (e.g. skim milk), milk solids, condensed milk, and any combination thereof. Generally, dairy products comprise an amount of dairy protein (for example, whey protein containing beta-lactoglobulin, alpha-lactalbumin, or serum albumin) and the like. In some embodiments, the dairy product may be replaced with an amount of a non-dairy component, such as, for example, soymilk, soy protein, almond milk, coconut milk, and any combination thereof. The dairy and non-dairy products can include variations in amount of fat contained therein; from full-fat to low fat to non-fat (i.e. zero fat).

In an exemplary embodiment, oil and/or fats include butter, ghee, shortening, flaxseed oil, walnut oil, macadamia nut oil, canola oil, palm corn oil, soybean oil, olive oil, margarine, vegetable oils, coconut oil, lard, tallow, and the like.

In some embodiments, the baking ingredients comprise from about 30 wt-% to about 70 wt-%, from about 35 wt-% to about 70 wt-%, from about 40 wt-% to about 70 wt-%, from about 45 wt-% to about 70 wt-%, from about 45 wt-% to about 65 wt-%, or from about 45 wt-% to about 60 wt-% of the allulose-containing baked good composition.

### Optional Additional Ingredients

In some embodiments, one or more of the allulose-containing baked good compositions described herein optionally further comprise additional ingredients. The presence of additional ingredients will vary based on the type of allulose-containing baked good. Exemplary additional ingredients include, but are not limited to, for example, additional sweeteners (including non-nutritive sweeteners and partially-nutritive sweeteners), water, salt, other starchy ingredients, additional leavening agents (e.g. baking soda, yeast or the like), alcohol and/or flavoring liquor, stabilizing agents, bulking agents (e.g. maltodextrin, polydextrose, xanthan gum, guar gum, glucose syrup of any kind, soluble fiber of any kind, starch of any kind, oligosaccharides of any kind, and the like), natural and/or artificial colors, natural and/or artificial flavors (e.g. vanilla), coconut and/or coconut-derived products, spices, fruits (including whole, diced, mushed, purees, concentrates, and such) and/or fruit-derived products, vegetables and/or vegetable-derived products, legumes and/or legume-derived products, nuts and/or nut-derived products, preservatives, stabilizers, antioxidants, emulsifiers, proteins, amino acids, vitamins, minerals, and the like.

In some embodiments, the optional additional ingredients comprises up to 50%, 45%, 40%, 35%, 30%, 25%, 20%, 15%, 10%, or 5% by weight of the allulose-containing baked good composition.

### Non-Nutritive Sweeteners

In some embodiments, one or more of the allulose-containing baked good compositions described herein may optionally further comprise a non-nutritive sweetener in combination with the allulose. Non-nutritive sweeteners (e.g. high potency sweeteners) can be included in the allulose-containing baked good compositions described herein to help increase the minor amount of sweetness that is lost upon addition of allulose (as allulose is 70% as sweet as sucrose). The loss of this sweetness might or might not be perceived by a typical consumer based on the other ingredients in the formulations and the total sugar replacement levels. Exemplary non-nutritive sweeteners (i.e. zero calorie sweeteners) include natural and artificial sweeteners, including high-potency sweeteners.

Exemplary natural non-nutritive sweeteners are those found in nature which may be in raw, extracted, purified, or any other form (e.g. via fermentation, bio-conversion), singularly or in combination thereof and characteristically have a sweetness potency greater than sucrose, fructose, or glucose. Non-limiting examples of natural zero calorie non-nutritive sweeteners include steviol glycosides, including rebaudioside A (Reb A), rebaudioside B (Reb B), rebaudioside C (Reb C), rebaudioside D (Reb D), rebaudioside D2 (Reb D2), rebaudioside D4 (Reb D4), rebaudioside E (Reb E), rebaudioside F (Reb F), rebaudioside G (Reb G), rebaudioside H (Reb H), rebaudioside I (Reb I), rebaudioside J (Reb J), rebaudioside K (Reb K), rebaudioside L (Reb L), rebaudioside M2 (Reb M2), rebaudioside M (Reb M) (also known as REB X), rebaudioside N (Reb N), rebaudioside O (Reb O), rebaudioside S (Reb S), rebaudioside T (Reb T), rebaudioside U (Reb U), rebaudioside V (Reb V), rebaudioside W (Reb W), rebaudioside Zl (Reb Z1), rebaudioside Z2 (Reb Z2), and enzymatically glucosylated steviol glycosides; amino acids; tryptophans; steviolmonoside; steviolbioside; dulcoside A; dulcoside B; rubusoside; stevia; stevioside; mogroside; mogroside IV; mogroside V; mogroside VI; iso-mogroside V; grosmomoside; neomogroside; siamenoside; Luo Han Guo sweetener; monk fruit; siamenoside; monatin and its salts (monatin SS, RR, RS, SR); curculin; glycyrrhizic acid and its salts; thaumatin; monellin; mabinlin; brazzein; hemandulcin; phyllodulcin; glycyphyllin; phloridzin; trilobtain; baiyunoside; osladin; polypodoside A; pterocaryoside A; pterocaryoside B; mukurozioside; phlomisoside I; periandrin I; abrusoside A; and cyclocarioside I. Natural high-potency sweeteners also include modified natural high-potency sweeteners.

Exemplary synthetic zero calorie (i.e. high-potency) sweeteners include sucralose, potassium acesulfame (Acesulfame-potassium), aspartame, alitame, saccharin, neohesperidin dihydrochalcone, cyclamate, neotame, advantame, N-[N-[3-(3-hydroxy-4-methoxyphenyl)propyl]-L-a-aspartyl]-L-phenylalanine I-methyl ester, N-[N-[3-(3-hydroxy-4-methoxyphenyl)-3-methylbutyl]-L-a-aspartyl]-L-phenylalanine I-methyl ester, N-[N-[3-(3-methoxy-4-hydroxyphenyl)propyl]-L-a-aspartyl]-L-phenylalanine I-methyl ester, salts thereof and the like. Synthetic high-potency sweeteners also include modified synthetic high-potency sweeteners.

In some embodiments, one or more of the allulose-containing baked good compositions described herein comprise less than about 10 wt-%, less than about 5 wt-%, less than about 1 wt-%, less than about 0.1 wt-%, or less than about 0.01 wt-%, or 0 wt-% of the allulose-containing baked good composition.

### Exemplary Allulose-Containing Baked Good Compositions

In some embodiments, the baked goods that comprise the allulose-containing baked good compositions described herein include baked goods that can benefit from completely replacing the nutritive sweeteners or partially replacing a portion of the nutritive sweetener (including, e.g., sucrose) contained in the baked good. Beneficially, the allulose-containing baked good compositions can continue to be used to make the allulose-containing baked good therefrom via known processes for making such baked good without any additional or extensive processing steps. Additionally, in some embodiments no modifications to the baking conditions (e.g. time and temperature) for making full sugar baked goods are required to make allulose-containing baked goods from the one or more allulose-containing baked good composition described herein.

Exemplary allulose-containing baked goods that can be made from the one or more allulose-containing baked good compositions described herein include, for example: cakes, cookies, rolls, pies, pastries, tarts, tortes, sweet breads, sweet biscuits, muffins, and the like. In some embodiments, the allulose-containing baked good is selected from a yellow cake, a sugar cookie, a blondie brownie, and the like. In another embodiment, the allulose-containing baked good is a cake or a cookie.

### Leavening Acid and Allulose Systems

Still further embodiments are directed to a food ingredient system for reducing the browning of an allulose-containing baked good. In one embodiment, the food ingredient system comprises allulose and one or more leavening acid selected from cream of tartar, citric acid, glucono delta-lactone, monocalcium phosphate, sodium acid pyrophosphate, and sodium aluminum phosphate. In another embodiment, the food ingredient system described herein further comprises a nutritive (or partially nutritive) sweetener, non-nutritive sweetener, and/or baking soda. Beneficially, the food ingredient system described herein can be provided as a ready-to-use, single-source ingredient for addition to a baked good composition in which want to partially or completely replace the nutritive sweetener contained in the full sugar baked good composition with allulose while obtaining a reduced sugar and/or calorie baked good having comparable browning to the full sugar baked good.

### Reducing Excessive Browning in Allulose-Containing Baked Goods

Still other embodiments are directed to using one or more of the allulose-containing baked good compositions described herein to produce an allulose-containing baked good having comparable browning to a full-sugar baked good comprising a composition containing a nutritive sweetener.

Further disclosed herein is the use of allulose as a sugar replacement (or means to reduce sugar content and/or caloric content) and leavening acids for reducing browning in allulose-containing baked good compositions.

In an additional embodiment, one or more of the allulose-containing baked good compositions described herein mitigate or reduce the browning (color and flavor change) of the allulose-containing baked goods made therefrom in addition to ensuring no undesirable flavor development occurs as a result of the addition of the leavening acids.

In an additional embodiment, one or more of the allulose-containing baked good compositions described herein do not adversely affect the shape of the risen (i.e. baked) allulose-containing baked goods made therefrom while also achieving a reduction in crumb browning.

In an additional embodiment, one or more of the allulose-containing baked good compositions described herein do not adversely affect the flavor of the allulose-containing baked goods made therefrom while also achieving a reduction in crumb browning.

In some embodiments, the allulose-containing baked goods comprising an allulose-containing composition described herein have a more fluffy, airy crumb than the full sugar controls without the allulose (or baked goods comprising compositions containing allulose but not the one or more leavening acids described herein).

Subject matter contemplated by the present disclosure is set out in the following numbered embodiments:
1. An allulose-containing baked good composition comprising:
   (i) from about 1 wt-% to about 25 wt-% allulose (dry basis);
   (ii) from about 0.3 wt-% to about 3 wt-% leavening acid, wherein the leavening acid is cream of tartar, citric acid, glucono delta-lactone, monocalcium phosphate, sodium acid pyrophosphate, sodium aluminum phosphate, or a mixture thereof;
   (iii) a nutritive sweetener at least partially replaced by the allulose; and
   (iv) a combination of at least three baking ingredients comprising flour, eggs and/or egg derived products, milk and/or other dairy or non-dairy products, oil and/or fats.
2. The composition according to embodiment 1, wherein the allulose is a liquid syrup comprising at least about 85% allulose and about 15% other monosaccharides and/or disaccharides, at least about 90% allulose and about 10% other monosaccharides and/or disaccharides, or at least about 95% allulose and about 5% other monosaccharides and/or disaccharides.
3. The composition according to embodiment 1 or 2, wherein the allulose comprises from about 2 wt-% to about 25 wt-%, from about 5 wt-% to about 15 wt-%, or about 10 wt-% to about 15 wt-% of the composition on a dry basis.
4. The composition according to any one of embodiments 1-3, wherein the leavening acid is (i) cream of tartar and comprises from about 0.5 wt-% to about 2.5 wt-% of the composition, (ii) glucono delta-lactone and comprises from about 0.3 wt-% to about 1.8 wt-% or from about 0.85 wt-% to about 1.8 wt-% of the composition, (iii) citric acid and comprises from about 0.5 wt-% to about 2 wt-% of the composition; (iv) monocalcium phosphate and comprises from about 0.31 wt-% to about 0.85 wt-% of the composition; (v) sodium acid pyrophosphate and comprises from about 0.3 wt-% to about 1.8 wt-% of the composition; or (vi) sodium aluminum phosphate and comprises from about 0.3 wt-% to about 1.8 wt-% of the composition.
5. The composition according to any one of embodiments 1-4, further comprises a leavening agent, wherein the leavening agent is baking soda in an amount of from about 0.5 wt-% to about 1.5 wt-% of the composition.
6. The composition according to any one of embodiments 1-5, wherein the nutritive sweetener is sucrose.
7. The composition according to any one of embodiments 1-6, wherein the baking ingredients comprise from about 30 wt-% to about 70 wt-% of the composition.
8. The composition according to any one of embodiments 1-7, further comprising one or more additional baking ingredient selected from salt, water, other starchy ingredient, non-nutritive sweetener, partially-nutritive sweetener, alcohol, flavoring liquor, stabilizing agent, bulking agent, colorant, flavorant, spice, fruit, fruit-derived product, vegetable, vegetable-derived product, legume, legume-derived product, nut, nut-derived product, preservative, stabilizer, antioxidant, emulsifier, protein, amino acid, vitamin, and mineral.
9. The composition according to any one of embodiments 1-8, wherein the composition has at least a 10% sugar reduction, 20% sugar reduction, 25% sugar reduction, 30% sugar reduction, 40% sugar reduction, 50% sugar reduction, 75% sugar reduction, or at least 100% sugar reduction in comparison to a full sugar baked good composition.
10. The composition according to any one of embodiments 1-9, wherein the composition has at least a 1% calorie reduction, at least a 5% calorie reduction, at least a 10% calorie reduction, at least a 15% calorie reduction, at least a 20% calorie reduction, or at least a 25% calorie reduction in comparison to a full sugar baked good composition.
11. The composition according to any one of embodiments 1-10, wherein the composition is a cake composition, cookie composition, roll composition, pie composition, pastry composition, tart composition, torte composition, sweet bread composition, sweet biscuit composition, or muffin composition.
12. The composition according to any one of embodiments 1-11, wherein the composition is a cake composition.
13. An allulose-containing baked good comprising the composition according to any one of embodiments 1-12, wherein the allulose-containing baked good has comparable browning to a full sugar baked good comprising a composition containing a nutritive sweetener as measured by (i) L color measurement having a “Delta L” with a minimum of −13, wherein “L” represents a change in color from black to white; (ii) “a” and/or “b” color measurements having at least one of a “Delta a” with a maximum of +6.5 and/or a “Delta b” with a maximum of +2.5, wherein the “Delta” measurement is the sample value minus a full sugar control value, and wherein “a” represents a change in color from green to red, and “b” represents a change in color from blue to yellow; or (iii) a combination of (i) and (ii).
14. Use of the composition according to any one of embodiments 1-12 to produce an allulose-containing baked good having comparable browning to a full-sugar baked good comprising a composition containing a nutritive sweetener.
15. A method for reducing the browning of an allulose-containing baked good comprising:
   (i) replacing at least a portion of a nutritive sweetener in a baked good composition with allulose;
   (ii) adding one or more leavening acid selected from cream of tartar, citric acid, glucono delta-lactone, monocalcium phosphate, sodium acid pyrophosphate, and sodium aluminum phosphate to the composition;
   (iii) baking the composition; and
   (iv) obtaining the allulose-containing baked good.
16. The method according to embodiment 15, wherein the allulose-containing baked good has comparable browning to a full sugar baked good comprising a composition containing a nutritive sweetener as measured by (i) L color measurement having a “Delta L” with a minimum of −13, wherein “L” represents a change in color from black to white; (ii) “a” and/or “b” color measurements having at least one of a “Delta a” with a maximum of +6.5 and/or a “Delta b” with a maximum of +2.5, wherein the “Delta” measurement is the sample value minus a full sugar control value, and wherein “a” represents a change in color from green to red, and “b” represents a change in color from blue to yellow; or (iii) a combination of (i) and (ii).
17. The method according to embodiment 15 or 16, wherein the allulose-containing baked good is a cake, cookie, roll, pie, pastry, tart, torte, sweet bread, sweet biscuit, or muffin.
18. The method according to any one of embodiments 15-17, wherein the allulose-containing baked good is a cake.
19. A food ingredient system comprising allulose and one or more leavening acid selected from cream of tartar, citric acid, glucono delta-lactone, monocalcium phosphate, sodium acid pyrophosphate, and sodium aluminum phosphate.
20. The system according to embodiment 19, further comprising a nutritive, partially-nutritive and/or non-nutritive sweetener, and, optionally, baking soda.

### EXAMPLES

The embodiments described hereinabove are further defined in the following non-limiting Examples. It should be understood that these Examples, while describing various embodiments of the invention, are given by way of illustration only. From the above discussion and these Examples, one skilled in the art can ascertain the essential characteristics of the invention and, without departing from the spirit and scope thereof, change and modify the embodiments described herein to adapt it to various usages and conditions. Thus, various modifications of the embodiments described herein, in addition to those shown and described herein, will be apparent to those skilled in the art from the foregoing description. Any such modifications are also intended to be encompassed by the claims appended hereto. The features disclosed in the description and Examples set forth herein, or the following claims, or the accompanying drawings, expressed in their specific forms or in terms of a means for performing the disclosed function, or a method or process for attaining the disclosed result, as appropriate, may, separately, or in any combination of such features, be utilized for realizing the invention in diverse forms thereof.

A yellow cake formulation including both baking soda and baking powder was used as the cake model to allow all leavening acids to be changeable in the formulation. However, the baking powder (which is a combination of baking soda and cream of tartar) was substituted with additional baking soda and some cream of tartar, which is commonly used as a leavening acid in baking powder formulations. The Full Sugar Control and Negative Control were used as basis of comparison with various modifications to the leavening agents to assess impact on reduction of excessive browning.

The Allulose used in the yellow cake formulations was ASTRAEA® Liquid Allulose, with 95% purity and at around 74% solids. The use of allulose in this formulation provides around 40% sugar reduction, and around 10% calorie reduction (320 calories/100 g for full sugar control; and 290 calories/100 g for all allulose containing samples).

TABLE 2
Yellow Cake Formulations

| | Full Sugar | 10% Allulose (dry basis) |
|---|---|---|
| | Control | (Neg Control) |
| Ingredient | % | % |
| Sugar | 23.89% | 13.89% |
| Shortening | 5.94% | 5.94% |
| Cake flour | 22.49% | 22.49% |
| Nonfat dry milk | 4.95% | 4.95% |
| Baking soda | 0.69% | 0.69% |
| Cream of tartar | 0.31% | 0.31% |
| Cellulose gum | 0.25% | 0.25% |
| Xanthan gum | 0.04% | 0.04% |
| Water | 22.69% | 19.27% |
| Liquid Allulose | 0% | 13.42% |
| Vanilla extract | 0.80% | 0.80% |
| Vegetable oil | 4.95% | 4.95% |
| Whole eggs | 13.00% | 13.00% |
| Total: | 100% | 100% |

TABLE 3
Yellow Cake Formulations with Cream of Tartar

| Ingredient | % | % | % |
|---|---|---|---|
| Sugar | 13.89% | 13.89% | 13.89% |
| Shortening | 5.94% | 5.94% | 5.94% |
| Cake flour | 22.49% | 21.60% | 21.95% |
| Nonfat dry milk | 4.95% | 4.95% | 4.95% |
| Baking soda | 0.69% | 0.69% | 0.69% |
| Cream of tartar | 0.85% | 1.20% | 1.80% |
| Cellulose gum | 0.25% | 0.25% | 0.25% |
| Xanthan gum | 0.04% | 0.04% | 0.04% |
| Water | 18.73% | 19.27% | 19.27% |
| Liquid Allulose | 13.42% | 13.42% | 13.42% |
| Vanilla extract | 0.80% | 0.80% | 0.80% |
| Vegetable oil | 4.95% | 4.95% | 4.95% |
| Whole eggs | 13.00% | 13.00% | 13.00% |
| Total: | 100% | 100% | 100% |

TABLE 4
Yellow Cake Formulations with Citric Acid

| Ingredient | % | % |
|---|---|---|
| Sugar | 13.89% | 13.89% |
| Shortening | 5.94% | 5.94% |
| Cake flour | 22.49% | 22.49% |
| Nonfat dry milk | 4.95% | 4.95% |
| Baking soda | 0.69% | 1.00% |
| Cellulose gum | 0.25% | 0.25% |
| Xanthan gum | 0.04% | 0.04% |
| Water | 19.01% | 18.70% |
| Citric acid | 0.57% | 0.57% |
| Liquid Allulose | 13.42% | 13.42% |
| Vanilla extract | 0.80% | 0.80% |
| Vegetable oil | 4.95% | 4.95% |
| Whole eggs | 13.00% | 13.00% |
| Total: | 100% | 100% |

TABLE 5
Yellow Cake Formulations with Glucono Delta-Lactone

| Ingredient | % | % | % | % |
|---|---|---|---|---|
| Sugar | 13.89% | 13.89% | 13.89% | 13.89% |
| Shortening | 5.94% | 5.94% | 5.94% | 5.94% |
| Cake flour | 22.49% | 21.95% | 21.60% | 21.00% |
| Nonfat dry milk | 4.95% | 4.95% | 4.95% | 4.95% |
| Baking soda | 0.69% | 0.69% | 0.69% | 0.69% |
| Glucono Delta-Lactone | 0.31% | 0.85% | 1.20% | 1.80% |
| Cellulose gum | 0.25% | 0.25% | 0.25% | 0.25% |
| Xanthan gum | 0.04% | 0.04% | 0.04% | 0.04% |
| Water | 19.27% | 19.27% | 19.27% | 19.27% |
| Liquid Allulose | 13.42% | 13.42% | 13.42% | 13.42% |
| Vanilla extract | 0.80% | 0.80% | 0.80% | 0.80% |
| Vegetable oil | 4.95% | 4.95% | 4.95% | 4.95% |
| Whole eggs | 13.00% | 13.00% | 13.00% | 13.00% |
| Total: | 100% | 100% | 100% | 100% |

The cakes were made according to the following process:
1. In mixer bowl, combine sugar and shortening. Blend on speed 1 for 2 min., scraping once after 1 min.
2. Combine remaining dry ingredients in a separate bowl.
3. Add dry ingredients to shortening/sugar mix and blend on speed 1 for 1-2 minutes to combine, then scrape bowl.
4. Combine wet ingredients, then add to mixer bowl. Using the paddle attachment, blend the wet ingredients into the dry ingredients on speed #1 for about 30 seconds.
5. Stop mixer and scrape bowl thoroughly.
6. Resume mixing on speed #2 and blend for 2-3 minutes.
7. Portion 500 g batter into 8-inch diameter cake pans prepared with vegetable oil spray and bake in a conventional oven at 350° F. for 30 minutes.

### Example 1

### Cream of Tartar Leavening Acid Evaluations

The leavening acid cream of tartar (tartaric acid or potassium bitartrate) was chosen for exploration to mitigate brown color and flavor development. The percentage by weight of the acid added was compensated for by changes in the percentage by weight of water or flour.

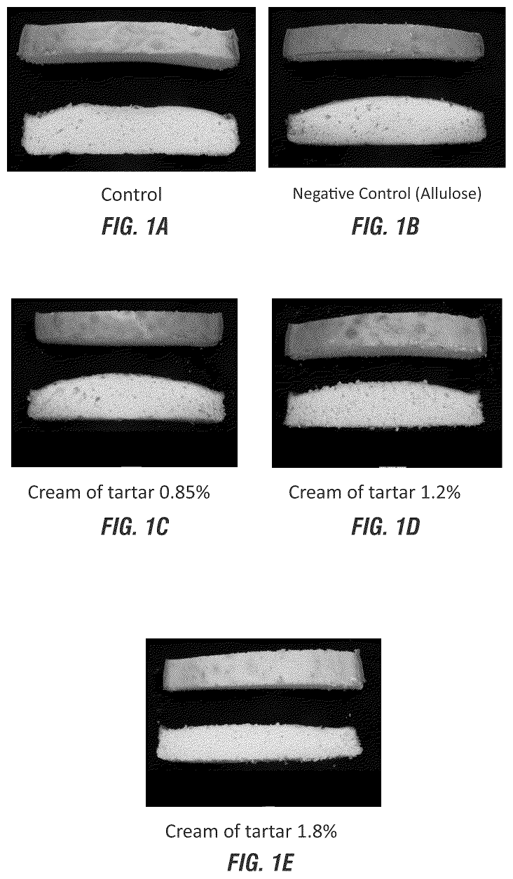

The cake formulations shown in Table 3 (above) were made to contain a range of levels of cream of tartar (0.85%, 1.20%, 1.80%), increased beyond the level found in the control and negative control formulas (0.31% as shown in Table 2). FIGS. 1A-1E show photographs of the finished cake cross-sections containing cream of tartar above the levels in the Control and Negative Control (FIGS. 1C-1E), in comparison to Control (FIG. 1A) and Negative Control (FIG. 1B).

The testing demonstrates that excessive browning is an issue when including allulose as a replacement for sucrose, definitely more apparent in light colored sweet baked goods, such as the yellow cakes evaluated. Mitigation of this color/flavor development is possible by modifying the type and level of leavening acid added as shown in FIGS. 1A-1E. Notably, the yellow cake made with allulose and additional cream of tartar shows favorable results in a range of ≥0.85% and ≤1.80% for the reduction in browning, apparent both on the crust and in the crumb.

### Example 2

### Citric Acid Leavening Acid Evaluations

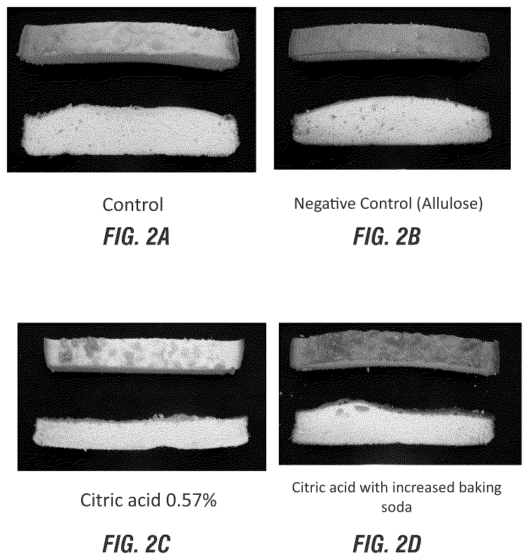

The leavening acid citric acid was chosen for exploration to mitigate brown color and flavor development. The percentage by weight of the acid added was compensated for by changes in the percentage by weight of water or flour. The cake formulations shown in Table 4 (above) were made to contain 0.57% citric acid with original baking soda amount (0.69%) and with a higher level of baking soda (1.00%). Citric acid was added at 0.57% level in place of cream of tartar originally present in the control formulation (0.31%). The citric acid was used along with an increase in baking soda (1% instead of 0.69% as in the control) as well, which resulted in an improvement in crumb browning. FIGS. 2A-2D shows photographs of the finished cake cross-sections containing the citric acid and backing soda (FIGS. 2C-2D) in comparison to Control (FIG. 2A) and Negative Control (FIG. 2B). This testing demonstrates that citric acid can aid in crust/crumb browning reduction. When the additional soda is added, the cake improves in overall appearance. The browning reduction is improved as well.

### Example 3

### Glucono Delta-Lactone Leavening Acid Evaluations

The leavening acid Glucono delta-lactone was chosen for exploration to mitigate brown color and flavor development. The percentage by weight of the acid added was compensated for by changes in the percentage by weight of water or flour. The cake formulations shown in Table 5 (above) contain a range of levels of glucono delta-lactone (0.31%, 0.85%, 1.20%, 1.80%).

Glucono delta-lactone has a similar neutralizing value to cream of tartar, and initially was used at similar levels (0.31% as the same level of cream of tartar in control and negative control). At 0.31% level, the color appearance is slightly improved, but still pretty different that negative control. 0.85% shows some improvement over browning, both on the crust and in the crumb. 1.20% gives more significant improvement to crumb browning, and crust browning as well. 1.80% maintains good crumb color, but dramatically increases paleness of top crust.

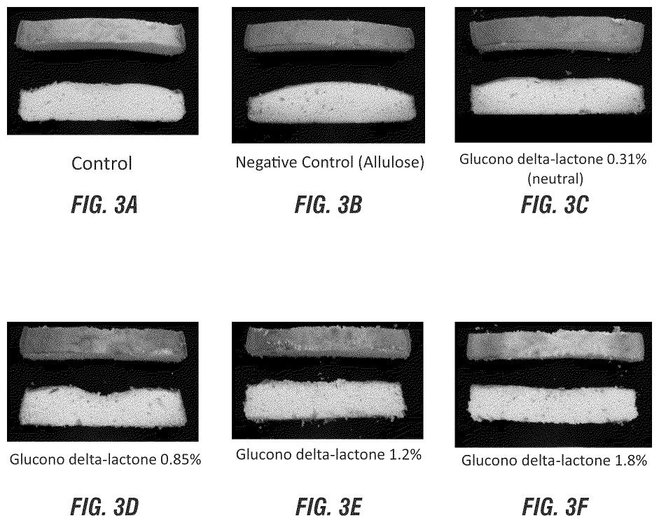

These results are shown in FIGS. 3A-3F where photographs of the finished cake cross-sections in comparison to Control (FIG. 3A) and Negative Control (FIG. 3B) are provided. As shown in the figures, Glucono delta-lactone yields cake results similar to those of cream of tartar, with significant mitigation of crumb browning. More favorable results were seen in a usage range of ≥0.85%, ≤1.80% (FIGS. 3D-3F).

### Example 4

### Ideal Ranges if Leavening Acids in Yellow Cake for Color Measurement, Cake Height, Moisture Levels, and Water Activity

The full sugar control, allulose (negative control), and the preferred leavening acid levels based on the initial testing described herein were baked again. Table 6 shows these formulations. The full sugar control formulation uses 23.89% sugar (sucrose). Allulose is used at 10% dry basis levels to reduce the sugar/calorie of the cake.

TABLE 6
Yellow Cake Formulations with Preferred Ranges of Leavening Acids

| | | Allulose | Allulose w/ | Allulose w/ | Allulose w/ |
|---|---|---|---|---|---|
| | | (Neg | citric acid & | cream of | glucono |
| | Control | Control) | baking soda | tartar | delta-lactone |
| Ingredient | % | % | % | % | % |
| Sugar | 23.89% | 13.89% | 13.89% | 13.89% | 13.89% |
| Shortening | 5.94% | 5.94% | 5.94% | 5.94% | 5.94% |
| Cake flour | 22.49% | 22.49% | 22.49% | 21.60% | 21.60% |
| Nonfat dry milk | 4.95% | 4.95% | 4.95% | 4.95% | 4.95% |
| Baking soda | 0.69% | 0.69% | 1.00% | 0.69% | 0.69% |
| Cream of Tartar | 0.31% | 0.31% | 0% | 1.20% | 0% |
| Glucono Delta-Lactone | 0% | 0% | 0% | 0% | 1.20% |
| Cellulose gum | 0.25% | 0.25% | 0.25% | 0.25% | 0.25% |
| Xanthan gum | 0.04% | 0.04% | 0.04% | 0.04% | 0.04% |
| Water | 22.69% | 19.27% | 18.70% | 19.27% | 19.27% |
| Citric acid | 0% | 0% | 0.57% | 0% | 0% |
| Liquid Allulose | 0% | 13.42% | 13.42% | 13.42% | 13.42% |
| Vanilla extract | 0.80% | 0.80% | 0.80% | 0.80% | 0.80% |
| Vegetable oil | 4.95% | 4.95% | 4.95% | 4.95% | 4.95% |
| Whole eggs | 13.00% | 13.00% | 13.00% | 13.00% | 13.00% |
| Total: | 100% | 100% | 100% | 100% | 100% |

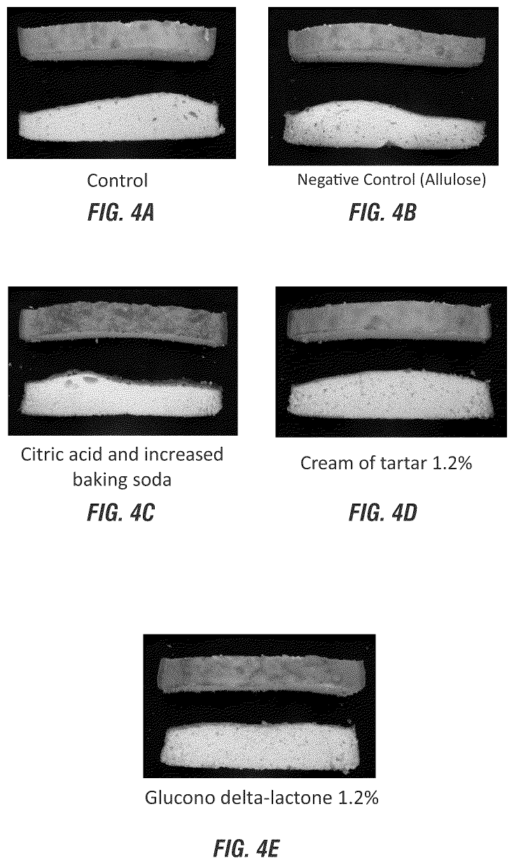

These results are shown in FIGS. 4A-4E where photographs of the finished cake cross-sections in comparison to Control (FIG. 4A) and Negative Control (FIG. 4B) are provided. As shown in the figures, the cake made with cream of tartar (FIG. 4D) and with glucono-delta lactone (FIG. 4E) showed a slightly higher rise compared to control. Cake made with glucono delta-lactone (FIG. 4E) had a higher rise but did not have a domed shape; it even had a minor amount of concavity in the middle. The cake with citric acid and increased level of baking soda (FIG. 4C) had a lower rise compared to the control, and a darker crust of all samples. These results are further evaluated below for cake height and other attributes.

### Quantification of Cake Colors

Cake color (expressed as L* a* b* values) were assessed using Konica Minolta handheld colorimeter for a quantitative measure of the decrease in browning. The color assessment measured the top crust and the interior crumb of the cake about 1.5 to 2 inches from the edge and at the middle of a central slice of cake, resulting in 2 crust and 2 crumb measurements. Table 7 shows the values measured.

TABLE 7
Cake Color Measurement (L* a* b* values)

| Sample | Location | L* | a* | b* |
|---|---|---|---|---|
| Control | Edge crust | 62.28 | 8.06 | 42.29 |
| | Middle crust | 60.52 | 7.97 | 41.33 |
| | Edge crumb | 75.29 | −2.98 | 23.31 |
| | Middle crumb | 76.50 | −3.13 | 22.39 |
| Allulose | Edge crust | 47.53 | 17.81 | 37.89 |
| | Middle crust | 50.06 | 16.71 | 40.35 |
| | Edge crumb | 68.31 | 2.67 | 32.77 |
| | Middle crumb | 71.53 | −0.27 | 29.65 |
| Allulose with citric and | Edge crust | 41.48 | 18.46 | 27.14 |
| soda | Middle crust | 42.42 | 18.22 | 29.99 |
| | Edge crumb | 70.68 | 1.00 | 28.57 |
| | Middle crumb | 74.81 | −1.46 | 26.47 |
| Allulose with CoT | Edge crust | 48.70 | 17.20 | 38.55 |
| | Middle crust | 58.02 | 10.53 | 42.43 |
| | Edge crumb | 73.88 | −2.44 | 24.27 |
| | Middle crumb | 70.57 | −2.98 | 24.71 |
| Allulose with GDL | Edge crust | 45.92 | 17.29 | 37.25 |
| | Middle crust | 48.78 | 12.36 | 37.58 |
| | Edge crumb | 87.09 | −2.69 | 19.79 |
| | Middle crumb | 70.72 | −3.42 | 20.73 |

The crust and crumb values were then averaged. Table 8 shows the values measured as an average of both crusts and crumbs (average of 5 different samples). Difference of values from control is calculated and listed as “Delta” values (sample value minus full sugar control value).

TABLE 8
Cake Color Measurement (L* a* b* values)

| | L | a | b | Delta L | Delta a | Delta b |
|---|---|---|---|---|---|---|
| Control | 68.65 | 2.48 | 32.33 | — | — | — |
| Allulose with citric | 57.35 | 9.06 | 28.04 | −9.49 | 5.745 | −5.60 |
| and soda | | | | | | |
| Allulose with CoT | 62.79 | 5.58 | 32.49 | −4.04 | 2.27 | −1.16 |
| Allulose with GDL | 63.13 | 5.89 | 28.84 | −3.71 | 2.58 | −4.81 |
| Allulose (Negative | 59.35 | 9.23 | 35.16 | −9.29 | 6.75 | 2.83 |
| Control) | | | | | | |

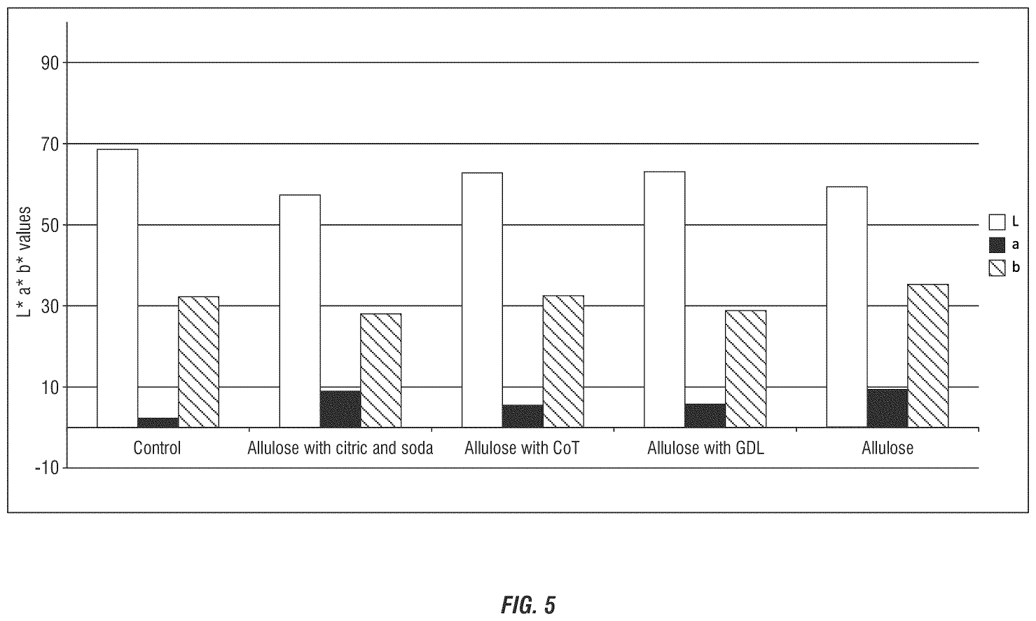

FIG. 5 shows the values of L* a* b* in Table 8 graphically. The graph shows the Control (full sugar) on the left and the Allulose (Negative Control) on the far right. The evaluated formulations with modified leavening acids are shown between these to demonstrate the L* a* b* values falling therebetween. In particular, “a” measures green to red (positive/higher values indicate more red as an indication of increased ‘browning’). The “b” measures blue to yellow (positive/higher values indicate more yellow). The “L” value represents lightness, black to white (higher values indicated lighter color). Overall combination of these (higher a, higher b, and lower L) is indicative of browning in sweet baked goods, including yellow cake. Table 8 also shows the “Delta” values for L* a* and b* (sample value minus full sugar control value). The table shows the allulose and leavening acids achieve the reduction of excessive browning as quantified by the following maximum ‘delta’ values: ‘Delta a’ maximum of +6.5, ‘Delta b’ maximum of +1.5, and/or optionally, ‘Delta L’ minimum of −10. As shown in Table 8 the allulose alone (negative control) does not meet the measured “Delta” values for L* a* and b* as there is excessive browning in comparison to the full sugar control.

### Cake Height in Millimeters

The heights of the cakes were measured across the cake round diameter in 3 places—about 1.5-2 inches from each side and at the center, using digital calipers. Table 9 shows the average height measurements for each cake.

TABLE 9
Cake Height (Average)

| Sample | Height (mm) |
|---|---|
| Control | 38.4 |
| Allulose | 37.3 |
| Allulose with citric and soda | 34.0 |
| Allulose with CoT | 40.5 |
| Allulose with GDL | 40.6 |

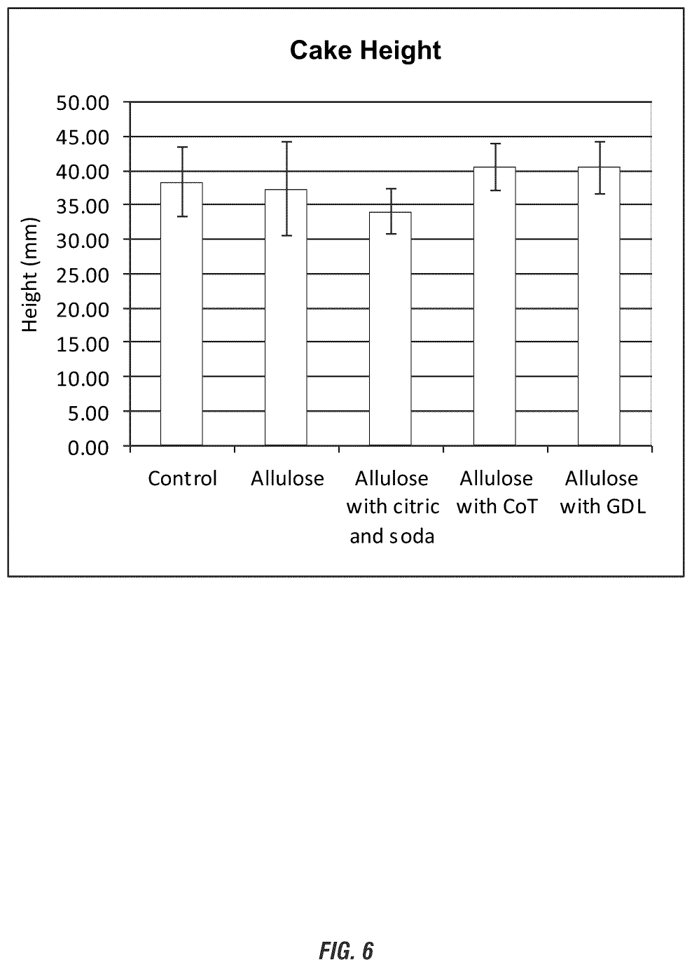

FIG. 6 shows the averages with standard deviation error bars for the data in Table 9, demonstrating that cakes made with cream of tartar and glucono delta-lactone showed slightly higher rise than other samples. The cake with citric acid and baking soda showed slightly lower rise than all other samples. All results are within acceptable range of full sugar control.

### Cake Moisture Levels

The moisture of the cakes was measured by cutting a slice of cake across the diameter and crumbing it, then measuring the moisture content as a percentage using a Sartorius MA35 Moisture Analyzer. Three replicates were performed for each sample. Table 10 shows the average moisture value for each cake.

TABLE 10
Cake Moisture (in Percent)

| Sample | Moisture % |
|---|---|
| Control | 31.6% |
| Allulose | 31.3% |
| Allulose with citric and soda | 30.0% |
| Allulose with CoT | 30.2% |
| Allulose with GDL | 30.2% |

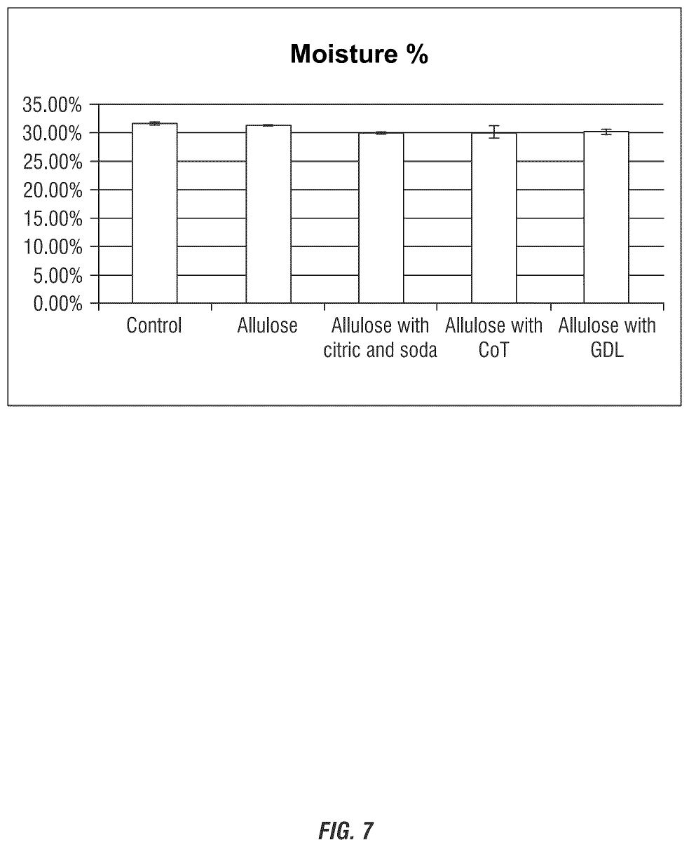

FIG. 7 shows graphically with standard deviation error bars the data of Table 10, demonstrating the moisture content is very comparable between control and all variables.

### Water Activity of Cakes

The water activity of the cakes was measured by cutting a slice of cake across the diameter and crumbing it, then finding the water activity using a Rotronic Hygrolab v4_11 Benchtop Indicator. Table 11 shows the water activity for each cake.

TABLE 11
Cake Water Activity Values

| Sample | Water Activity |
|---|---|
| Control | 0.89 |
| Allulose | 0.89 |
| Allulose with citric and soda | 0.88 |
| Allulose with CoT | 0.89 |
| Allulose with GDL | 0.89 |

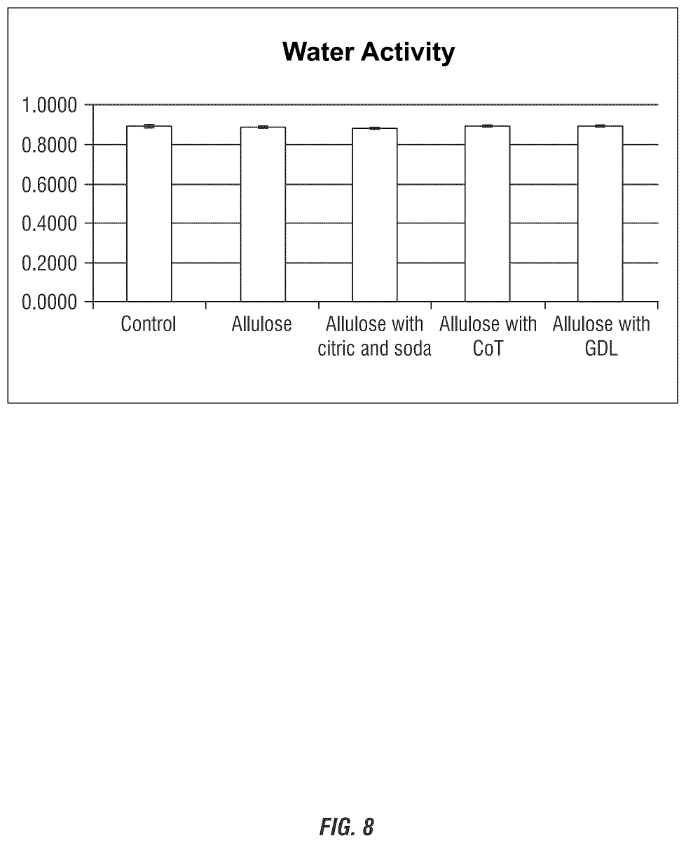

FIG. 8 shows graphically the data of Table 11, demonstrating the water activity is very comparable between control and all variables.

### Sensory Perception of Cakes

A sensory evaluation of all the cakes was performed by a group of eight tasters to discern differences in the samples with different leavening acids from the Control and Negative Control (Allulose). The following is a summary of the comments given for each sample:
Allulose negative control: has a toasted, somewhat burnt aroma, and is denser than control, demonstrating that the allulose results in excessive browning and change in flavor.
Allulose with citric acid and increased baking soda: has some visual/analytical improvement to browning, relatively less improvement compared to the other 2 samples. Also had denser texture like the allulose negative control.
Allulose with cream of tartar: perceived as closest to control in brown appearance and flavor, slightly more tender and fluffy texture-wise.
Allulose with glucono delta-lactone: had a visually appealing color. Overall, it was the most tender sample in the set. Perceived as sweeter, with a “cleaner” sweet taste and good vanilla cake flavor.
None of the 3 leavening acid samples had any off notes/off tastes due to the use of these leavening acids. None of the samples were unacceptable from general characteristics of a yellow cake.

### Example 5

### Cream of Tartar Leavening Acid Evaluations for Additional Color Assessment, and Measurement of Cake Height, Moisture, and Water Activity

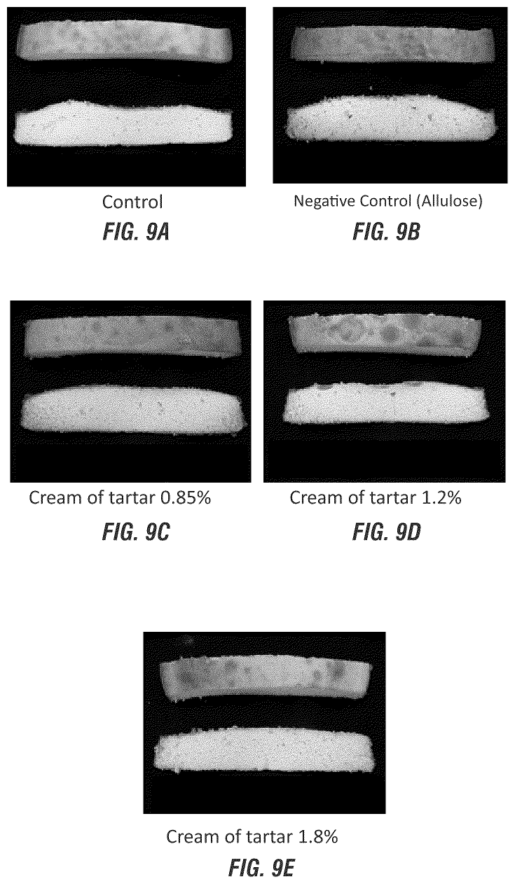

Additional cakes with increases in cream of tartar were baked to characterize the color, particularly 0.85% and 1.8% usage levels. The same cake formulations in Table 3 (above) were made to contain a range of levels of cream of tartar (0.85%, 1.20%, 1.80%), increased beyond the level found in the control and negative control formulas (0.31% as shown in Table 2). FIGS. 9A-9E show photographs of the finished cake cross-sections containing cream of tartar above the levels in the Control and Negative Control (FIGS. 9C-9E), in comparison to Control (FIG. 9A) and Negative Control (FIG. 9B). Two cakes were baked and measured for control, negative control, and 0.85%, 1.2% and 1.8% cream of tartar levels at different times, and the data for each variable was averaged. This data and information was combined with initial analytical data for control, negative control, and 1.2% usage levels (as descried in Example 4) and the data here reflect the averages of those samples, accounting for slight differences to the L, a, b, and delta L, delta a, delta b values compared to Example 4 data.

Cake color (expressed as L* a* b* values) were assessed using Konica Minolta handheld colorimeter for a quantitative measure of the decrease in browning. The color assessment measured the top crust and the interior crumb of the cake about 1.5 to 2 inches from the edge and at the middle of a central slice of cake, resulting in 2 crust and 2 crumb measurements. Table 12 shows the values measured and Table 13 shows the overall averages.

TABLE 12
Cake Color Measurement (L* a* b* values)

| Sample | Location | L* | a* | b* |
|---|---|---|---|---|
| Control | Edge crust | 62.28 | 8.06 | 42.29 |
| | Middle crust | 60.52 | 7.97 | 41.33 |
| | Edge crumb | 75.29 | −2.98 | 23.31 |
| | Middle crumb | 76.50 | −3.13 | 22.39 |
| Allulose | Edge crust | 47.53 | 17.81 | 37.89 |
| | Middle crust | 50.06 | 16.71 | 40.35 |
| | Edge crumb | 68.31 | 2.67 | 32.77 |
| | Middle crumb | 71.53 | −0.27 | 29.65 |
| Allulose with 0.85% | Edge crust | 51.85 | 16.26 | 39.92 |
| CoT | Middle crust | 58.08 | 10.31 | 42.03 |
| | Edge crumb | 71.19 | −1.10 | 25.26 |
| | Middle crumb | 74.97 | −2.52 | 23.65 |
| Allulose with 1.2% | Edge crust | 52.38 | 12.70 | 38.59 |
| CoT | Middle crust | 59.76 | 7.39 | 38.95 |
| | Edge crumb | 75.14 | −2.41 | 23.72 |
| | Middle crumb | 72.24 | −2.90 | 23.26 |
| Allulose with 1.8% | Edge crust | 58.35 | 10.31 | 40.79 |
| CoT | Middle crust | 66.49 | 1.71 | 33.13 |
| | Edge crumb | 76.06 | −2.97 | 19.50 |
| | Middle crumb | 75.93 | −3.16 | 18.91 |

TABLE 13
Average Cake Color Measurement (L* a* b* values)

| Sample | L* | a* | b* |
|---|---|---|---|
| Control | 68.65 | 2.48 | 32.33 |
| Allulose | 59.35 | 9.23 | 35.16 |
| Allulose with 0.85% | 64.02 | 5.74 | 32.71 |
| CoT | | | |
| Allulose with 1.2% | 64.88 | 3.70 | 31.13 |
| CoT | | | |
| Allulose with 1.85% | 69.20 | 1.47 | 28.08 |
| CoT | | | |

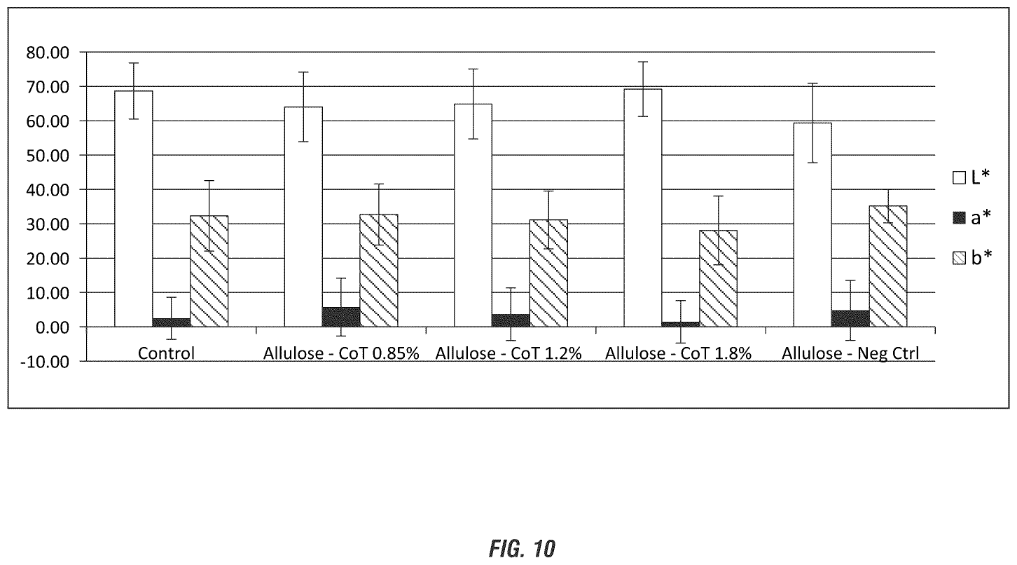

FIG. 10 shows the values of L* a* b* in Table 13 graphically. The graph shows the Control (full sugar) on the left and the Allulose (Negative Control) on the far right. The evaluated cake formulations with increased levels of cream of tartar leavening acid are shown between these to demonstrate the L* a* b* values falling therebetween. As shown, the allulose negative control had lower L* values and higher a* values than control in both the crust and crumb. The cakes with allulose and 0.85%, 1.2%, and 1.8% cream of tartar increase the L* values and decrease the a* values slightly more with each increase in usage, bringing the higher usage level results closer to control.

Table 14 also shows the “Delta” values for L* a* and b* (sample value minus full sugar control value). All the values for crust and crumb for each cake variable was averaged to find the values to use in Delta value calculation.

TABLE 14
Average Delta values (L* a* b*)

| | | | | Delta | Delta | Delta |
|---|---|---|---|---|---|---|
| Sample | L* | a* | b* | L* | a* | b* |
| Control | 68.65 | 2.48 | 32.33 | — | — | — |
| Allulose - CoT 0.85% | 64.02 | 5.74 | 32.71 | −4.62 | 3.26 | 0.38 |
| Allulose - CoT 1.2% | 64.88 | 3.70 | 31.13 | −3.77 | 1.22 | −1.20 |
| Allulose - CoT 1.8% | 69.20 | 1.47 | 28.08 | 0.56 | −1.01 | −4.25 |
| Allulose - Neg Control | 59.35 | 9.23 | 35.16 | −9.29 | 6.75 | 2.83 |

All Delta values for the cakes made with additional cream of tartar (at usage levels of 0.85%, 1.2%, and 1.8%) provide the improvement in browning according to the criteria that Delta L* values are greater than −10, Delta a* values are less than +6.5, and Delta b* values are less than a maximum of +2.5, or preferably a maximum of +1.5. This contrasts to the negative control's Delta a* and b* values, which do not conform to these standards as needed. Notably, the negative control barely conforms to the patent claims for Delta L* values (citric acid and soda value in Table 8). This testing further demonstrates that excessive browning is an issue when including allulose as a replacement for sucrose. Mitigation of this color change is achieved by modifying the acid leavening agent cream of tartar in the range of ≥0.85% and ≤1.80% for the reduction in browning, apparent both on the crust and in the crumb.

The heights of the cake formulations in Table 3 were measured across the cake round diameter in 3 places—about 1.5-2 inches from each side and at the center, using digital calipers. Table 15 shows the average height measurements for each cake.

TABLE 15
Cake Height (Average)

| Sample | Height (mm) |
|---|---|
| Control | 36.67 |
| Allulose with 0.85% CoT | 39.12 |
| Allulose with 1.2% CoT | 38.77 |
| Allulose with 1.8% CoT | 33.03 |
| Allulose | 37.70 |

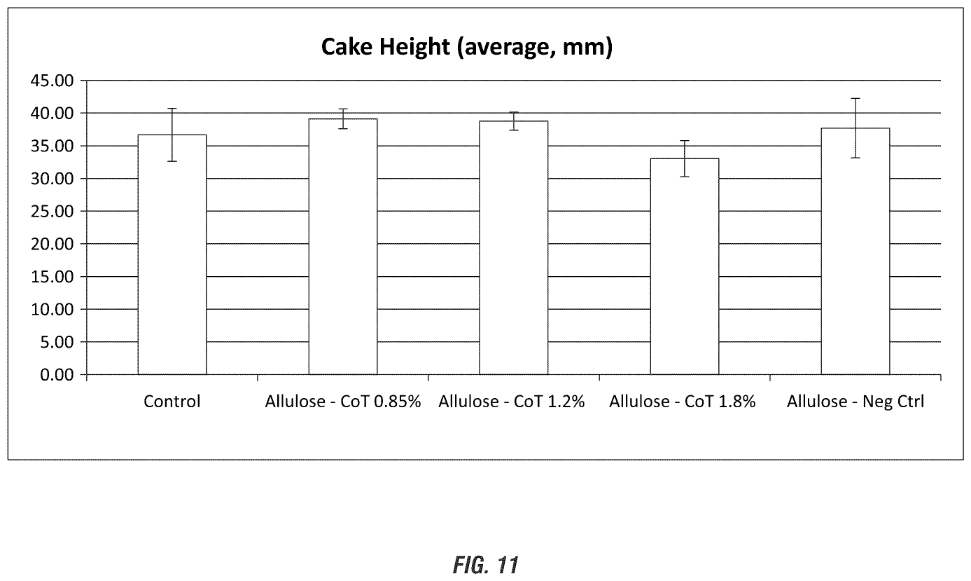

FIG. 11 shows the averages with standard deviation error bars for the data in Table 15, demonstrating that cakes made with cream of tartar showed higher rise on average but fell within the standard deviation range of Control, with the exception of the 1.8% cream of tartar cakes which had lower rises on average. All results are within acceptable range of full sugar control.

### Cake Moisture Levels

The moisture of the cakes was measured by cutting a slice of cake across the diameter and crumbing it, then measuring the moisture content as a percentage using a Sartorius MA35 Moisture Analyzer. Three replicates were performed for each sample. Table 16 shows the average moisture value for each cake.

TABLE 16
Cake Moisture (in Percent)

| Sample | Moisture % |
|---|---|
| Control | 31.85% |
| Allulose with 0.85% CoT | 29.75% |
| Allulose with 1.2% CoT | 30.43% |
| Allulose with 1.8% CoT | 30.39% |
| Allulose | 32.19% |

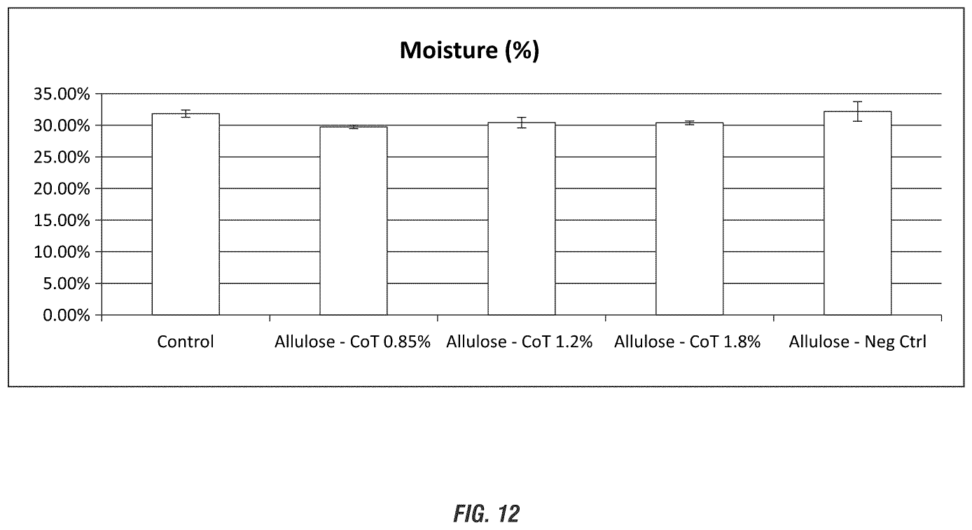

FIG. 12 shows graphically with standard deviation error bars the data of Table 16, demonstrating the moisture content is very comparable between control and all variables.

### Water Activity of Cakes

The water activity of the cakes was measured by cutting a slice of cake across the diameter and crumbing it, then finding the water activity using a Rotronic Hygrolab v4_11 Benchtop Indicator. Table 17 shows the water activity for each cake.

TABLE 17
Cake Water Activity Values

| Sample | Water Activity |
|---|---|
| Control | 0.88 |
| Allulose with 0.85% CoT | 0.87 |
| Allulose with 1.2% CoT | 0.89 |
| Allulose with 1.8% CoT | 0.88 |
| Allulose | 0.89 |

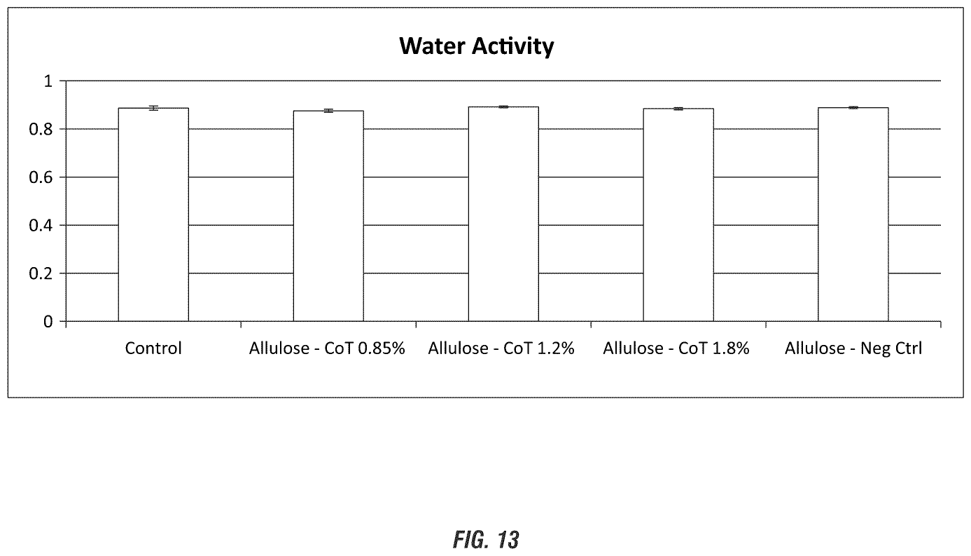

FIG. 13 shows graphically the data of Table 17, demonstrating the water activity is very comparable between control and all variables.

### Example 6

### Glucono Delta-Lactone Leavening Acid Evaluations for Additional Color Assessment, Cake Height, Moisture, and Water Activity

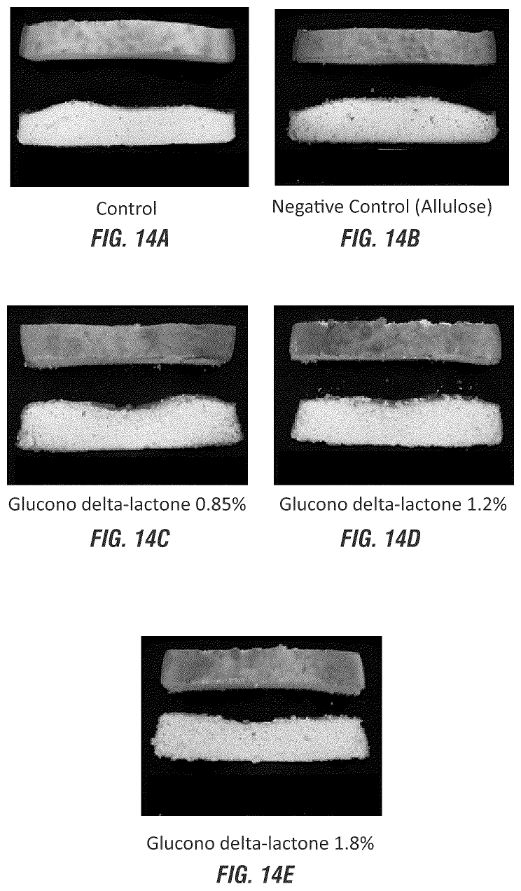

Additional cakes with increases in glucono delta-lactone were baked to characterize the color, particularly 0.85% and 1.8% usage levels. The same cake formulations in Table 5 (above) were made to contain a range of levels of glucono delta-lactone (0.85%, 1.20%, 1.80%), increased beyond the level found in the control and negative control formulas (0.31% as shown in Table 2). FIGS. 14A-14E show photographs of the finished cake cross-sections containing glucono delta-lactone above the levels in the Control and Negative Control (FIGS. 14C-14E), in comparison to Control (FIG. 14A) and Negative Control (FIG. 14B). All cakes containing allulose and glucono delta-lactone show less crumb browning than the allulose negative control, though at 0.85% there is still a small amount of browning in the lower edges/corners. These cakes also show a slightly more open cell structure with generally larger bubbles, appearing less dense than the control or negative control.

Cake color (expressed as L* a* b* values) were assessed using Konica Minolta handheld colorimeter for a quantitative measure of the decrease in browning. The color assessment measured the top crust and the interior crumb of the cake about 1.5 to 2 inches from the edge and at the middle of a central slice of cake, resulting in 2 crust and 2 crumb measurements. Table 18 shows the values measured and Table 19 shows the overall averages. Two cakes were baked and measured for control, negative control, and 0.85%, 1.2% and 1.8% glucono delta-lactone levels at different times, and the data for each variable was averaged. This data and information was combined with initial analytical data for control, negative control, and 1.2% usage levels (as described in Example 4) and the data here reflect the averages of those samples, accounting for slight differences to the L, a, b, and delta L, delta a, delta b values compared to Example 4 data.

TABLE 18
Cake Color Measurement (L* a* b* values)

| Sample | Location | L* | a* | b* |
|---|---|---|---|---|
| Control | Edge crust | 62.28 | 8.06 | 42.29 |
| | Middle crust | 60.52 | 7.97 | 41.33 |
| | Edge crumb | 75.29 | −2.98 | 23.31 |
| | Middle crumb | 76.50 | −3.13 | 22.39 |
| Allulose | Edge crust | 47.53 | 17.81 | 37.89 |
| | Middle crust | 50.06 | 16.71 | 40.35 |
| | Edge crumb | 68.31 | 2.67 | 32.77 |
| | Middle crumb | 71.53 | −0.27 | 29.65 |
| Allulose with 0.85% | Edge crust | 44.71 | 18.31 | 34.65 |
| GDL | Middle crust | 47.82 | 13.31 | 35.86 |
| | Edge crumb | 70.28 | −2.57 | 23.37 |
| | Middle crumb | 69.12 | −3.12 | 22.15 |
| Allulose with 1.2% | Edge crust | 48.07 | 15.85 | 38.14 |
| GDL | Middle crust | 53.21 | 11.74 | 40.06 |
| | Edge crumb | 72.59 | −2.78 | 20.73 |
| | Middle crumb | 69.28 | −3.11 | 20.91 |
| Allulose with 1.8% | Edge crust | 54.05 | 12.89 | 43.01 |
| GDL | Middle crust | 60.33 | 5.09 | 38.34 |
| | Edge crumb | 70.05 | −2.98 | 16.79 |
| | Middle crumb | 69.44 | −2.77 | 17.59 |

TABLE 19
Average Cake Color Measurement (L* a* b* values)

| Sample | L* | a* | b* |
|---|---|---|---|
| Control | 68.65 | 2.48 | 32.33 |
| Allulose | 59.35 | 9.23 | 35.16 |
| Allulose with 0.85% GDL | 57.98 | 6.48 | 29.01 |
| Allulose with 1.2% GDL | 60.79 | 5.43 | 29.96 |
| Allulose with 1.85% GDL | 63.46 | 3.06 | 28.93 |

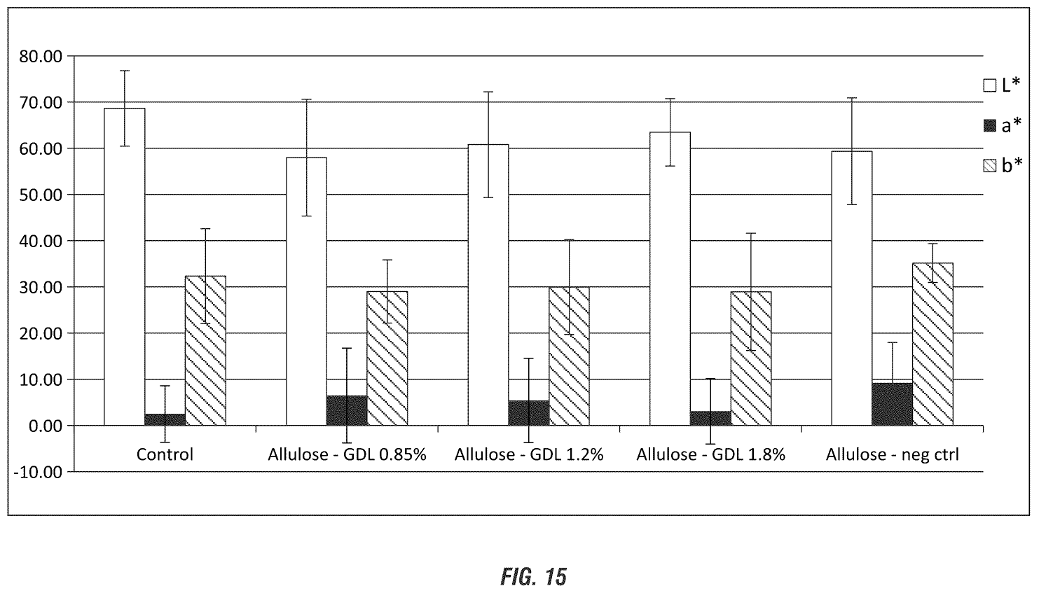

FIG. 15 shows the values of L* a* b* in Table 16 graphically. The graph shows the Control (full sugar) on the left and the Allulose (Negative Control) on the far right. The evaluated cake formulations with increased levels of glucono delta-lactone (GDL) leavening acid are shown between these to demonstrate the L* a* b* values falling therebetween. As shown, the allulose negative control had lower L* values and higher a* values than control in both the crust and crumb. The cakes with allulose and 0.85%, 1.2%, and 1.8% glucono delta-lactone increase the L* values and decrease the a* values slightly more with each increase in usage, bringing the higher usage level results closer to control.

Table 20 also shows the “Delta” values for L* a* and b* (sample value minus full sugar control value). All the values for crust and crumb for each cake variable was averaged to find the values to use in Delta value calculation.

TABLE 20
Average Delta values (L* a* b*)

| | | | | Delta | Delta | Delta |
|---|---|---|---|---|---|---|
| Sample | L* | a* | b* | L* | a* | b* |
| Control | 68.65 | 2.48 | 32.33 | — | — | — |
| Allulose - GDL 0.85% | 57.98 | 6.48 | 29.01 | −10.67 | 4.00 | −3.32 |
| Allulose - GDL 1.2% | 60.79 | 5.43 | 29.96 | −7.86 | 2.95 | −2.37 |
| Allulose - GDL 1.8% | 63.46 | 3.06 | 28.93 | −5.18 | 0.58 | −3.40 |
| Allulose - Neg Control | 59.35 | 9.23 | 35.16 | −9.29 | 6.75 | 2.83 |

Delta a* and b* values for the cakes made with glucono delta-lactone at usage levels of 0.85%, 1.2%, and 1.8% provide the improvement in browning.
The Delta a* values are less than +6.5, and Delta b* values are less than a maximum of +2.5, or preferably a maximum of +1.5.
As described herein, the Delta L* values, cakes made with 1.2% and 1.8% glucono delta-lactone are greater than −10, and the Delta L* values for the cakes made with lower amounts of GDL (0.85% glucono delta-lactone) slightly exceed the standard of greater than −10.
Notably, the negative control also is close to conforming to the Delta L* values as well, although it does not conform to Delta a* and b* claims.
This testing further demonstrates that excessive browning is an issue when including allulose as a replacement for sucrose.
Mitigation of this color change is achieved by modifying the acid leavening agent GDL in the range of >0.85% and ≤1.80% for the reduction in browning, apparent both on the crust and in the crumb.

The heights of the cake formulations in Table 5 were measured across the cake round diameter in 3 places—about 1.5-2 inches from each side and at the center, using digital calipers. Table 21 shows the average height measurements for each cake.

TABLE 21
Cake Height (Average)

| Sample | Height (mm) |
|---|---|
| Control | 36.67 |
| Allulose with 0.85% GDL | 43.06 |
| Allulose with 1.2% GDL | 41.14 |
| Allulose with 1.8% GDL | 36.16 |
| Allulose | 37.70 |

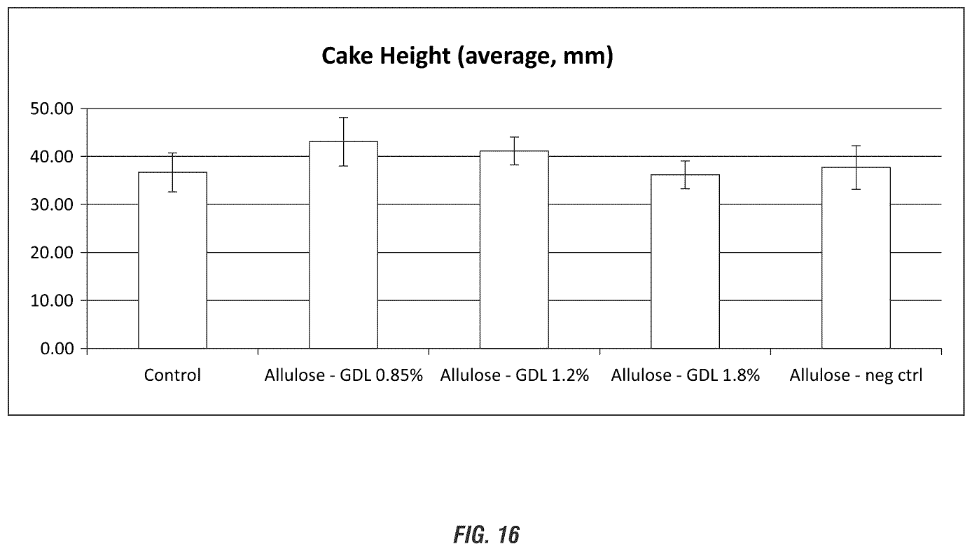

FIG. 16 shows the averages with standard deviation error bars for the data in Table 21, demonstrating that cakes made with 0.85% and 1.2% glucono delta-lactone were slightly higher in rise than Control and Negative Control, and cakes with 1.8% glucono delta-lactone were about the same height as controls.

### Cake Moisture Levels

The moisture of the cakes was measured by cutting a slice of cake across the diameter and crumbing it, then measuring the moisture content as a percentage using a Sartorius MA35 Moisture Analyzer. Three replicates were performed for each sample. Table 22 shows the average moisture value for each cake.

TABLE 22
Cake Moisture (in Percent)

| Sample | Moisture % |
|---|---|
| Control | 31.85% |
| Allulose with 0.85% GDL | 29.35% |
| Allulose with 1.2% GDL | 29.97% |
| Allulose with 1.8% GDL | 29.32% |
| Allulose | 32.19% |

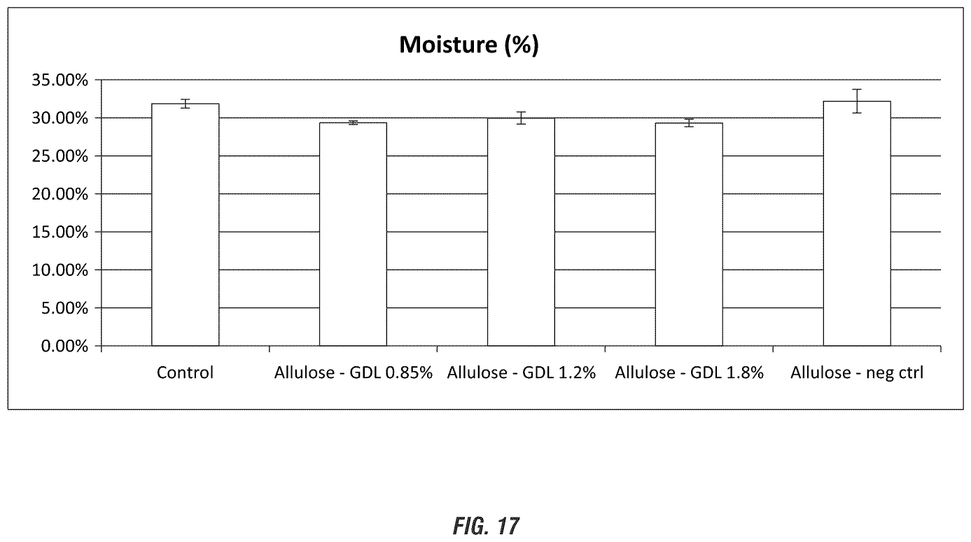

FIG. 17 shows graphically with standard deviation error bars the data of Table 22, demonstrating the moisture content is very comparable between control and all variables.

### Water Activity of Cakes

The water activity of the cakes was measured by cutting a slice of cake across the diameter and crumbing it, then finding the water activity using a Rotronic Hygrolab v4_11 Benchtop Indicator. Table 23 shows the water activity for each cake.

TABLE 23
Cake Water Activity Values

| Sample | Water Activity |
|---|---|
| Control | 0.88 |
| Allulose with 0.85% GDL | 0.88 |
| Allulose with 1.2% GDL | 0.89 |
| Allulose with 1.8% GDL | 0.88 |
| Allulose | 0.89 |

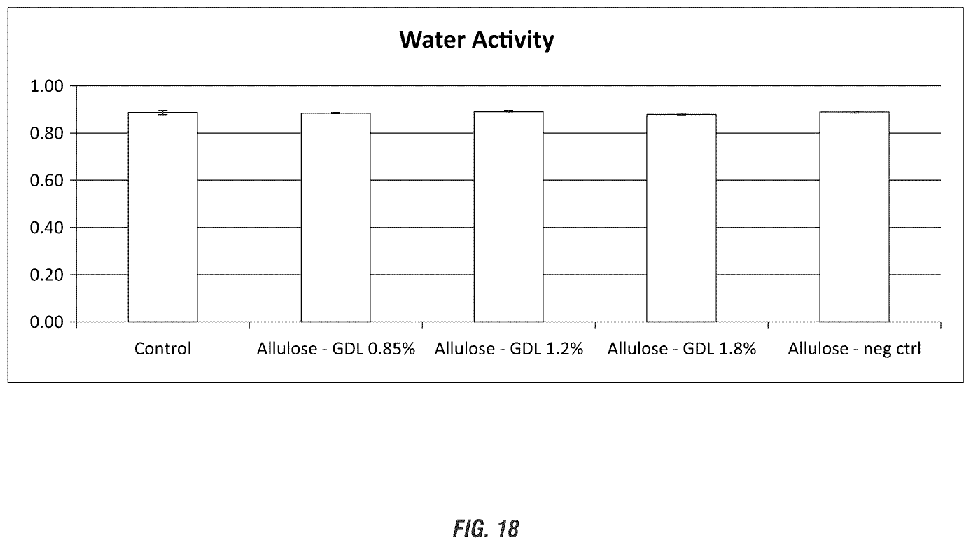

FIG. 18 shows graphically the data of Table 23, demonstrating the water activity is very comparable between control and all variables.

### Example 7

### Additional Leavening Acid Evaluations for Leavening and Browning Reduction

The additional acids monocalcium phosphate, sodium aluminum phosphate, and sodium acid pyrophosphate were evaluated to determine if they had similar browning reduction effects to cream of tartar and glucono delta lactone. Monocalcium phosphate, sodium aluminum phosphate, and sodium acid pyrophosphate were evaluated at the same level as cream of tartar in the control formula (0.31%) to initially confirm they functioned for leavening along with the browning reduction. The formulations are shown in Table 24.

TABLE 24
Cake Formulations with Acid Leavening Agents

| | | Allulose | Mono- | Sodium | |
|---|---|---|---|---|---|
| | | Neg | calcium | Aluminum | Sodium Acid |
| | Control | Control | Phosphate | Phosphate | Pyrophosphate |
| Ingredient | % | % | % | % | % |
| Sugar | 23.89% | 13.89% | 13.89% | 13.89% | 13.89% |
| Shortening | 5.94% | 5.94% | 5.94% | 5.94% | 5.94% |
| Cake flour | 22.49% | 22.49% | 22.49% | 22.49% | 22.49% |
| Nonfat dry milk | 4.95% | 4.95% | 4.95% | 4.95% | 4.95% |
| Baking soda | 0.69% | 0.69% | 0.69% | 0.69% | 0.69% |
| Cream of tartar | 0.31% | 0.31% | 0% | 0% | 0% |
| Monocalcium | 0.00% | 0.00% | 0.31% | 0% | 0% |
| Phosphate | | | | | |
| Monohydrate | | | | | |
| Sodium | 0.00% | 0.00% | 0% | 0.31% | 0% |
| Aluminum | | | | | |
| Phosphate | | | | | |
| Sodium Acid | 0.00% | 0.00% | 0.00% | 0.00% | 0.31% |
| Pyrophosphate | | | | | |
| Cellulose gum | 0.25% | 0.25% | 0.25% | 0.25% | 0.25% |
| Xanthan gum | 0.04% | 0.04% | 0.04% | 0.04% | 0.04% |
| Water | 22.69% | 19.27% | 19.27% | 19.27% | 19.27% |
| Liquid Allulose | 0.00% | 13.42% | 13.42% | 13.42% | 13.42% |
| (74.5% solids) | | | | | |
| Vanilla extract | 0.80% | 0.80% | 0.80% | 0.80% | 0.80% |
| Vegetable oil | 4.95% | 4.95% | 4.95% | 4.95% | 4.95% |
| Whole eggs | 13.00% | 13.00% | 13.00% | 13.00% | 13.00% |
| Total: | 100% | 100% | 100% | 100% | 100% |

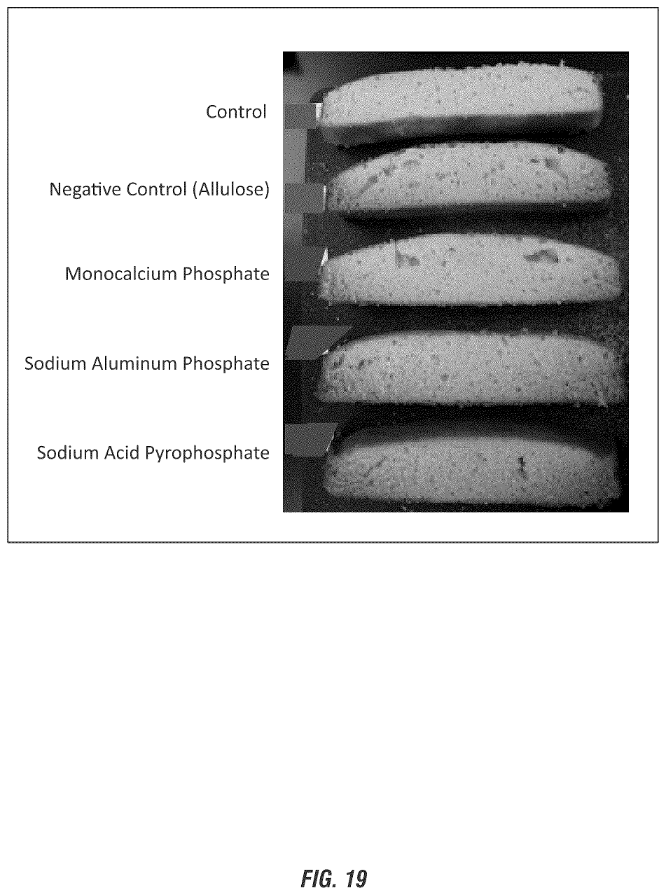

FIG. 19 shows a photograph of the finished cake cross-sections containing the evaluated leavening acids compared to Control and Negative Control (each labeled in FIG. 19). This initial evaluation at the levels of the Control (0.31%) for each leavening acid confirms they function similarly to cream of tartar at the same usage level in control and negative control, effectively provide leavening, plus slight effect on browning reduction.

### Example 8

### Monocalcium Phosphoate Leavening Acid Evaluations

Table 25 shows the formulation containing 0.85% monocalcium phosphate—increased beyond the level found in the control and negative control formulas (0.31%).

TABLE 25
Cake Formulations with Monocalcium Phosphate Leavening Acid

| | Monocalcium Phosphate - 0.85% |
|---|---|
| Ingredient | % |
| Sugar | 13.89% |
| Shortening | 5.94% |
| Cake flour | 21.95% |
| Nonfat dry milk | 4.95% |
| Baking soda | 0.69% |
| Monocalcium Phosphate | 0.85% |
| Monohydrate | |
| Cellulose gum | 0.25% |
| Xanthan gum | 0.04% |
| Water | 19.27% |
| Liquid Allulose (74.5% solids) | 13.42% |
| Vanilla extract | 0.80% |
| Vegetable oil | 4.95% |
| Whole eggs | 13.00% |
| | 100.00% |

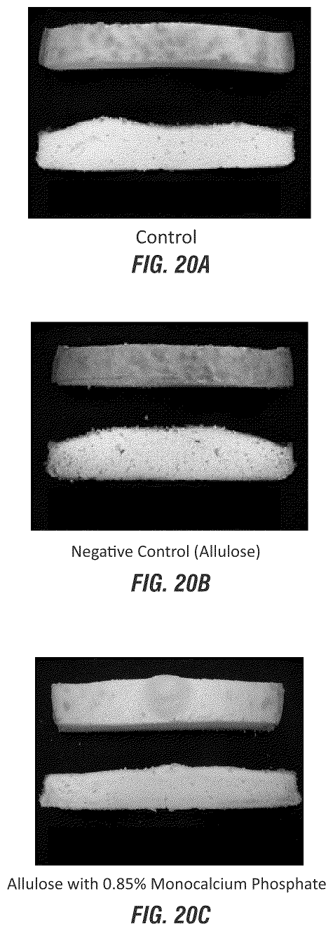

FIGS. 20A-20C shows photographs of the finished cake cross-section in comparison to control (FIG. 20A) and negative control (FIG. 20B). As shown in the FIG. 20C the increase of monocalcium phosphate leavening acid did reduce the crust and crumb browning, however it caused the cake to collapse to a dense and/or gummy crumb. Without being limited to a mechanism of action, the monocalcium phosphate's higher speed of reaction may require a lower limit of inclusion in the formulation less than about 0.85%, preferably >0.31% and <0.85%, such as >0.31% and <0.5%.

### Example 9

### Sodium Acid Pyrophosphate Leavening Acid Evaluations, Cake Height, Moisture, and Water Activity

Table 26 shows the formulations containing a range of levels of sodium acid pyrophosphate (SAPP)—0.85%, 1.20%, and 1.80%—increased beyond the level found in the control and negative control formulas (0.31%).

TABLE 26
Yellow Cake with Sodium Acid Pyrophosphate Formulations

| Ingredient | % | % | % |
|---|---|---|---|
| Sugar | 13.89% | 13.89% | 13.89% |
| Shortening | 5.94% | 5.94% | 5.94% |
| Cake flour | 21.95% | 21.60% | 21.00% |
| Nonfat dry milk | 4.95% | 4.95% | 4.95% |
| Baking soda | 0.69% | 0.69% | 0.69% |
| Sodium acid pyrophosphate | 0.85% | 1.20% | 1.80% |
| Cellulose gum | 0.25% | 0.25% | 0.25% |
| Xanthan gum | 0.04% | 0.04% | 0.04% |
| Water | 18.73% | 19.27% | 19.27% |
| Liquid Allulose (74.5% solids) | 13.42% | 13.42% | 13.42% |
| Vanilla extract | 0.80% | 0.80% | 0.80% |
| Vegetable oil | 4.95% | 4.95% | 4.95% |
| Whole eggs | 13.00% | 13.00% | 13.00% |
| Total: | 100% | 100% | 100% |

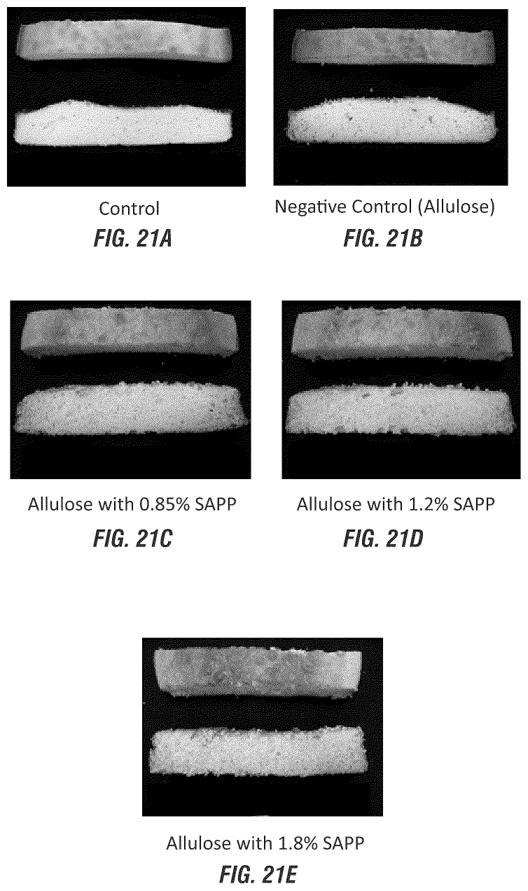

FIGS. 21A-21E show photographs of the finished cake cross-sections containing sodium acid pyrophosphate above the levels in the Control and Negative Control (FIGS. 21C-21E), in comparison to Control (FIG. 21A) and Negative Control (FIG. 21B). All cakes containing allulose and sodium acid pyrophosphate show less crumb browning than the allulose negative control, though the reduction is less dramatic at all usage levels, and the crumb in the corners of the cake with even the highest level of SAPP seems slightly darker, and the top crust of the cakes with SAPP generally remain fairly well browned. Notably, cakes made with sodium acid pyrophosphate were less domed than negative control, and the cake with 1.8% sodium acid pyrophosphate relatively level over the cake's surface. The leavening acid was effective in reducing the excessive browning.

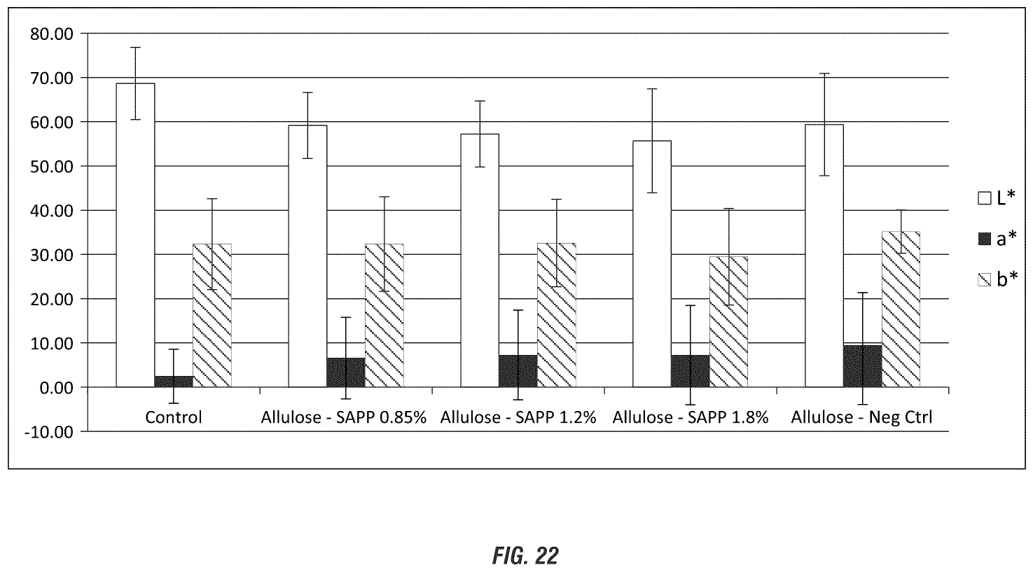

Cake color was assessed using Konica Minolta handheld colorimeter, measuring the top crust and the interior crumb of the cake about 1.5 to 2 inches from the edge and at the middle of a central slice of cake, resulting in 2 crust and 2 crumb measurements. Table 27 shows the values measured, Table 28 shows overall averages, and FIG. 22 shows these values graphically.

TABLE 27
Cake color expressed in L*a*b* Values

| | | L* | a* | b* |
|---|---|---|---|---|
| Control | Edge Crust | 62.28 | 8.06 | 42.29 |
| | Middle Crust | 60.52 | 7.97 | 41.33 |
| | Edge Crumb | 75.29 | −2.98 | 23.31 |
| | Middle Crumb | 76.50 | −3.13 | 22.39 |
| Allulose - | Edge Crust | 49.10 | 18.12 | 40.34 |
| SAPP .85% | Middle Crust | 56.83 | 11.61 | 43.93 |
| | Edge Crumb | 64.88 | −0.98 | 23.48 |
| | Middle Crumb | 65.78 | −2.43 | 21.63 |
| Allulose - | Edge Crust | 48.07 | 18.65 | 39.98 |
| SAPP 1.2% | Middle Crust | 53.84 | 14.26 | 43.31 |
| | Edge Crumb | 65.04 | −1.31 | 24.95 |
| | Middle Crumb | 62.00 | −2.48 | 22.10 |
| Allulose - | Edge Crust | 41.81 | 19.50 | 35.67 |
| SAPP 1.8% | Middle Crust | 48.93 | 15.71 | 42.55 |
| | Edge Crumb | 65.53 | −2.81 | 20.78 |
| | Middle Crumb | 66.43 | −3.45 | 18.90 |
| Allulose - Neg | Edge Crust | 47.53 | 17.81 | 37.89 |
| Control | Middle Crust | 50.06 | 16.71 | 40.35 |
| | Edge Crumb | 68.31 | 2.67 | 32.77 |
| | Middle Crumb | 71.53 | −0.27 | 29.65 |

TABLE 28
Average Cake Color Measurement (L* a* b* values)

| Sample | L* | a* | b* |
|---|---|---|---|
| Control | 68.65 | 2.48 | 32.33 |
| Allulose with 0.85% SAPP | 59.15 | 6.58 | 32.34 |
| Allulose with 1.2% SAPP | 57.23 | 7.28 | 32.58 |
| Allulose with 1.85% SAPP | 55.67 | 7.24 | 29.47 |
| Allulose - Neg Control | 59.35 | 9.23 | 35.16 |

As shown in FIG. 22, the cakes with allulose and 0.85%, 1.2%, and 1.8% sodium 10 aluminum phosphate increase the L* values and decrease the a* values slightly more with each increase in usage, bringing the higher usage level results closer to control. Though the crumb browning is reduced, the crust browning seems to persist, and is bringing the L* values down on average.

Table 29 also shows the “Delta” values for L* a* and b* (sample value minus full sugar control value). All the values for crust and crumb for each cake variable was averaged to find the values to use in Delta value calculation.

TABLE 29
Average Delta values (L* a* b*)

| | | | | Delta | Delta | Delta |
|---|---|---|---|---|---|---|
| Sample | L* | a* | b* | L* | a* | b* |
| Control | 68.65 | 2.48 | 32.33 | — | — | — |
| Allulose - SAPP | 59.15 | 6.58 | 32.34 | −9.50 | 4.10 | 0.01 |
| 0.85% | | | | | | |
| Allulose - SAPP 1.2% | 57.23 | 7.28 | 32.58 | −11.41 | 4.80 | 0.26 |
| Allulose - SAPP 1.8% | 55.67 | 7.24 | 29.47 | −12.97 | 4.76 | −2.86 |
| Allulose - Neg Control | 59.35 | 9.23 | 35.16 | −9.29 | 6.75 | 2.83 |

Delta L*, a* and b* values for the cakes made with SAPP at usage levels of 0.85% provide the improvement in browning according to all measurements.
The SAPP usage levels of 1.2%, and 1.8% provide the improvement in browning as well at Delta a* and b* values while the Delta L* values are greater than −10.
As demonstrated here the Delta L* values for the cakes made with the 1.2%, and 1.8% amounts of SAPP have a Delta L* value that is greater than −13.

### Cake Heights

The heights of the cake formulations in Table 26 were measured across the cake round diameter in 3 places—about 1.5-2 inches from each side and at the center, using digital calipers. Table 30 shows the average height measurements for each cake.

TABLE 30
Cake Height (Average)

| Sample | Height (mm) |
|---|---|
| Control | 36.67 |
| Allulose with 0.85% SAPP | 42.20 |
| Allulose with 1.2% SAPP | 42.04 |
| Allulose with 1.8% SAPP | 40.97 |
| Allulose | 37.70 |

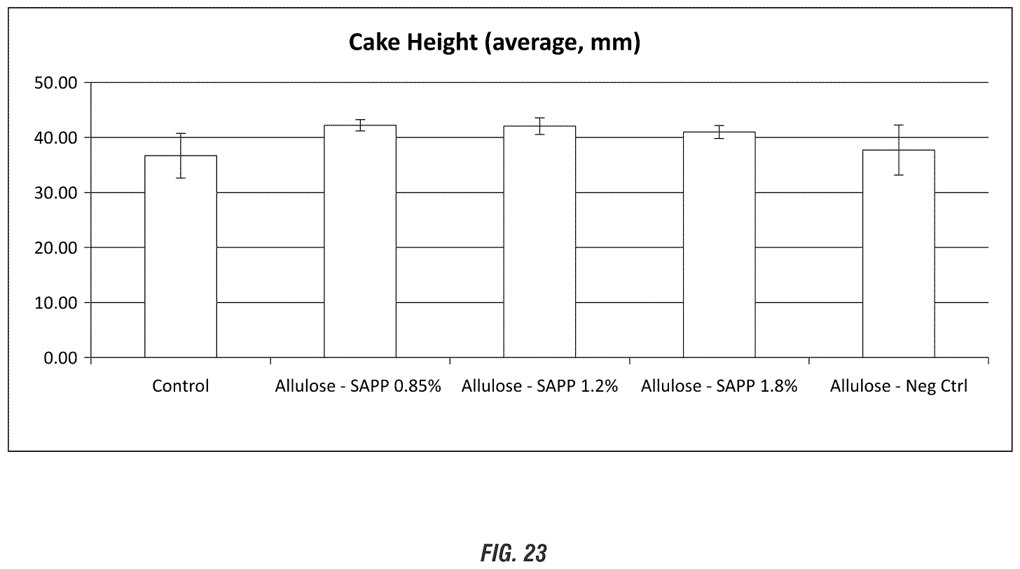

FIG. 23 shows the averages with standard deviation error bars for the data in Table 30, demonstrating that cakes made with sodium acid pyrophosphate were higher in rise on average just slightly higher than control.

### Cake Moisture Levels

The moisture of the cakes was measured by cutting a slice of cake across the diameter and crumbing it, then measuring the moisture content as a percentage using a Sartorius MA35 Moisture Analyzer. Three replicates were performed for each sample. Table 31 shows the average moisture value for each cake.

TABLE 31
Cake Moisture (in Percent)

| Sample | Moisture % |
|---|---|
| Control | 31.85% |
| Allulose with 0.85% SAPP | 29.77% |
| Allulose with 1.2% SAPP | 29.47% |
| Allulose with 1.8% SAPP | 28.91% |
| Allulose | 32.19% |

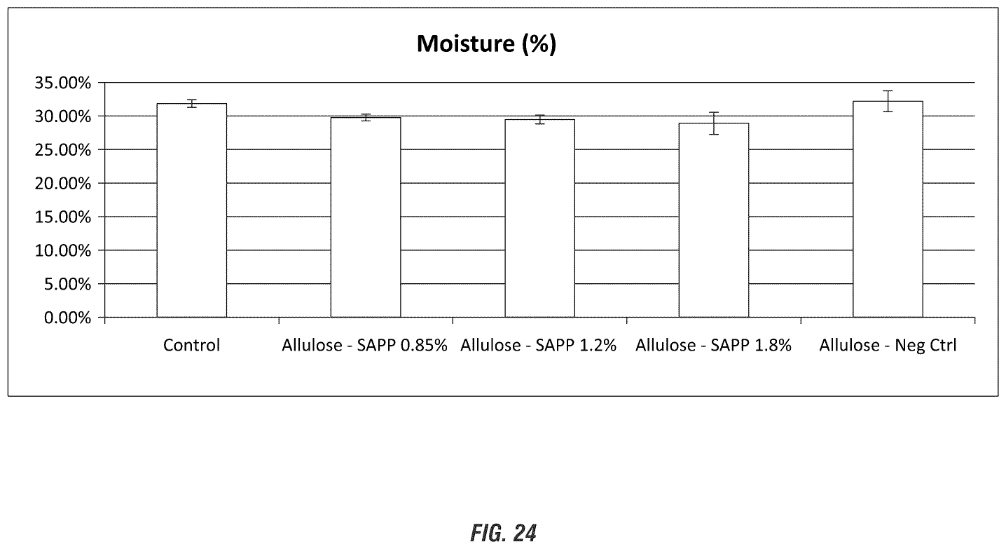

FIG. 24 shows graphically with standard deviation error bars the data of Table 31, demonstrating the cakes with sodium acid pyrophosphate have a moisture content that is slightly lower than but comparable to control and negative control.

### Water Activity of Cakes

The water activity of the cakes was measured by cutting a slice of cake across the diameter and crumbing it, then finding the water activity using a Rotronic Hygrolab v4_11 Benchtop Indicator. Table 32 shows the water activity for each cake.

TABLE 32
Cake Water Activity Values

| Sample | Water Activity |
|---|---|
| Control | 0.88 |
| Allulose with 0.85% SAPP | 0.87 |
| Allulose with 1.2% SAPP | 0.87 |
| Allulose with 1.8% SAPP | 0.87 |
| Allulose | 0.89 |

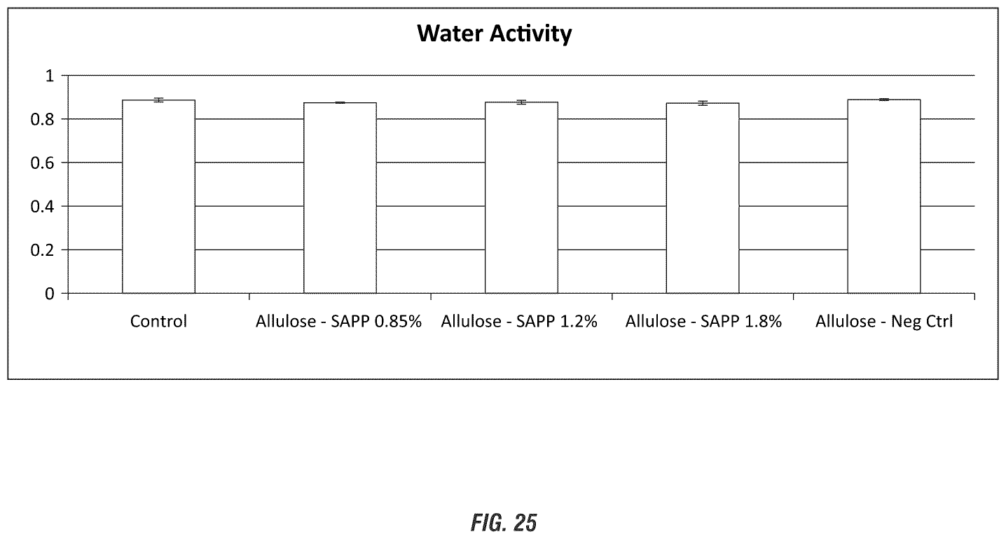

FIG. 25 shows graphically the data of Table 36, demonstrating the water activity is very comparable between control and all variables.

### Example 10

### Sodium Aluminum Phosphate Leavening Acid Evaluations, Cake Height, Moisture, And Water Activity

Table 33 shows the formulations containing a range of levels of sodium aluminum phosphate (SAP)—0.85%, 1.20%, and 1.80%—increased beyond the level found in the control and negative control formulas (0.31%).

TABLE 33
Yellow Cake with Sodium Aluminum Phosphate Formulations

| Ingredient | % | % | % |
|---|---|---|---|
| Sugar | 13.89% | 13.89% | 13.89% |
| Shortening | 5.94% | 5.94% | 5.94% |
| Cake flour | 21.95% | 21.60% | 21.00% |
| Nonfat dry milk | 4.95% | 4.95% | 4.95% |
| Baking soda | 0.69% | 0.69% | 0.69% |
| Sodium aluminum phosphate | 0.85% | 1.20% | 1.80% |
| Cellulose gum | 0.25% | 0.25% | 0.25% |
| Xanthan gum | 0.04% | 0.04% | 0.04% |
| Water | 18.73% | 19.27% | 19.27% |
| Liquid Allulose (74.5% solids) | 13.42% | 13.42% | 13.42% |
| Vanilla extract | 0.80% | 0.80% | 0.80% |
| Vegetable oil | 4.95% | 4.95% | 4.95% |
| Whole eggs | 13.00% | 13.00% | 13.00% |
| Total: | 100% | 100% | 100% |

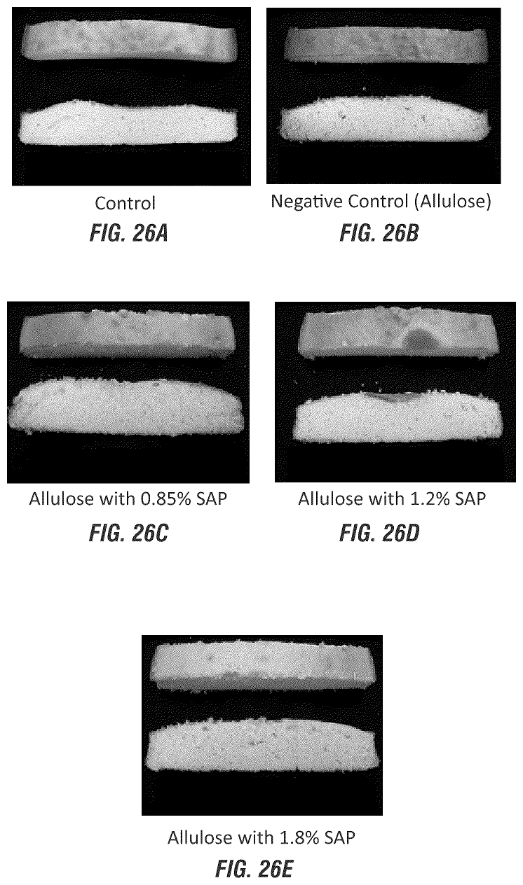

FIGS. 26A-26E show photographs of the finished cake cross-sections containing sodium aluminum phosphate above the levels in the Control and Negative Control (FIGS. 26C-26E), in comparison to Control (FIG. 26A) and Negative Control (FIG. 26B). All cakes containing allulose and sodium aluminum phosphate show less crumb browning than the allulose negative control, though at 0.85% there is still a small amount of browning in the lower edges/corners. The cake with 1.8% sodium aluminum phosphate had a significantly lighter top crust. But overall, it has been successful in reducing eh browning, and not significantly affecting the crumb structure and texture.

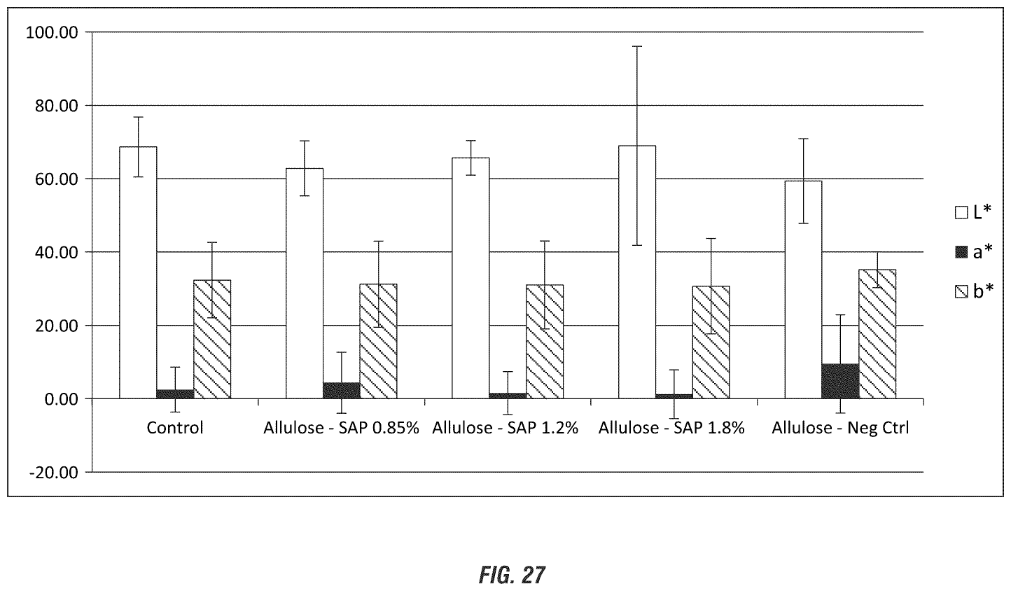

Cake color was assessed using Konica Minolta handheld colorimeter, measuring the top crust and the interior crumb of the cake about 1.5 to 2 inches from the edge and at the middle of a central slice of cake, resulting in 2 crust and 2 crumb measurements. Table 34 shows the values measured, Table 35 shows overall averages, and FIG. 27 shows these values graphically.

TABLE 34
Cake color expressed in L*a*b* Values

| | | L* | a* | b* |
|---|---|---|---|---|
| Control | Edge Crust | 62.28 | 8.06 | 42.29 |
| | Middle Crust | 60.52 | 7.97 | 41.33 |
| | Edge Crumb | 75.29 | −2.98 | 23.31 |
| | Middle Crumb | 76.50 | −3.13 | 22.39 |
| Allulose - SAP | Edge Crust | 54.19 | 15.16 | 42.85 |
| 0.85% | Middle Crust | 57.87 | 8.33 | 40.55 |
| | Edge Crumb | 69.98 | −2.91 | 20.35 |
| | Middle Crumb | 69.26 | −3.19 | 21.12 |
| Allulose - SAP | Edge Crust | 60.22 | 9.27 | 43.54 |
| 1.2% | Middle Crust | 64.48 | 3.93 | 40.68 |
| | Edge Crumb | 68.26 | −3.39 | 19.37 |
| | Middle Crumb | 69.71 | −3.66 | 20.44 |
| Allulose - SAP | Edge Crust | 61.19 | 11.42 | 47.34 |
| 1.8% | Middle Crust | 69.40 | 0.55 | 37.22 |
| | Edge Crumb | 73.26 | −3.66 | 19.24 |
| | Middle Crumb | 71.96 | −3.47 | 18.95 |
| Allulose - Neg | Edge Crust | 47.53 | 17.81 | 37.89 |
| Ctrl | Middle Crust | 50.06 | 16.71 | 40.35 |
| | Edge Crumb | 68.31 | 2.67 | 32.77 |
| | Middle Crumb | 71.53 | −0.27 | 29.65 |

TABLE 35
Average Cake Color Measurement (L* a* b* values)

| Sample | L* | a* | b* |
|---|---|---|---|
| Control | 68.65 | 2.48 | 32.33 |
| Allulose with 0.85% SAP | 62.82 | 4.35 | 31.22 |
| Allulose with 1.2% SAP | 65.67 | 1.54 | 31.01 |
| Allulose with 1.85% SAP | 68.95 | 1.21 | 30.69 |
| Allulose - Neg Control | 59.35 | 9.23 | 35.16 |

As shown in FIG. 27, the cakes with allulose and 0.85%, 1.2%, and 1.8% sodium aluminum phosphate increase the L* values and decrease the a* values slightly more with each increase in usage, bringing the higher usage level results closer to those of control cakes than those of the negative control cakes.

Table 36 also shows the “Delta” values for L* a* and b* (sample value minus full sugar control value). All the values for crust and crumb for each cake variable was averaged to find the values to use in Delta value calculation.

TABLE 36
Average Delta values (L* a* b*)

| | | | | Delta | Delta | Delta |
|---|---|---|---|---|---|---|
| Sample | L* | a* | b* | L* | a* | b* |
| Control | 68.65 | 2.48 | 32.33 | — | — | — |
| Allulose - SAP 0.85% | 62.82 | 4.35 | 31.22 | −5.82 | 1.87 | −1.11 |
| Allulose - SAP 1.2% | 65.67 | 1.54 | 31.01 | −2.98 | −0.94 | −1.32 |
| Allulose - SAP 1.8% | 68.95 | 1.21 | 30.69 | 0.31 | −1.27 | −1.64 |
| Allulose - Neg Control | 59.35 | 9.23 | 35.16 | −9.29 | | 2.83 |

All Delta values for the cakes made with additional sodium aluminum phosphate (at usage levels of 0.85%, 1.2%, and 1.8%) conform to the standards for browning improvement set forth in the patent—Delta L* values are greater than −10, Delta a* values are less than +6.5, and Delta b* values are less than +1.5. This contrasts to the negative control's Delta a* and b* values, which do not conform to these standards as needed.

### Cake Heights

The heights of the cake formulations in Table 33 were measured across the cake round diameter in 3 places—about 1.5-2 inches from each side and at the center, using digital calipers. Table 37 shows the average height measurements for each cake.

TABLE 37
Cake Height (Average)

| Sample | Height (mm) |
|---|---|
| Control | 36.67 |
| Allulose with 0.85% SAP | 44.84 |
| Allulose with 1.2% SAP | 42.15 |
| Allulose with 1.8% SAP | 40.01 |
| Allulose | 37.70 |

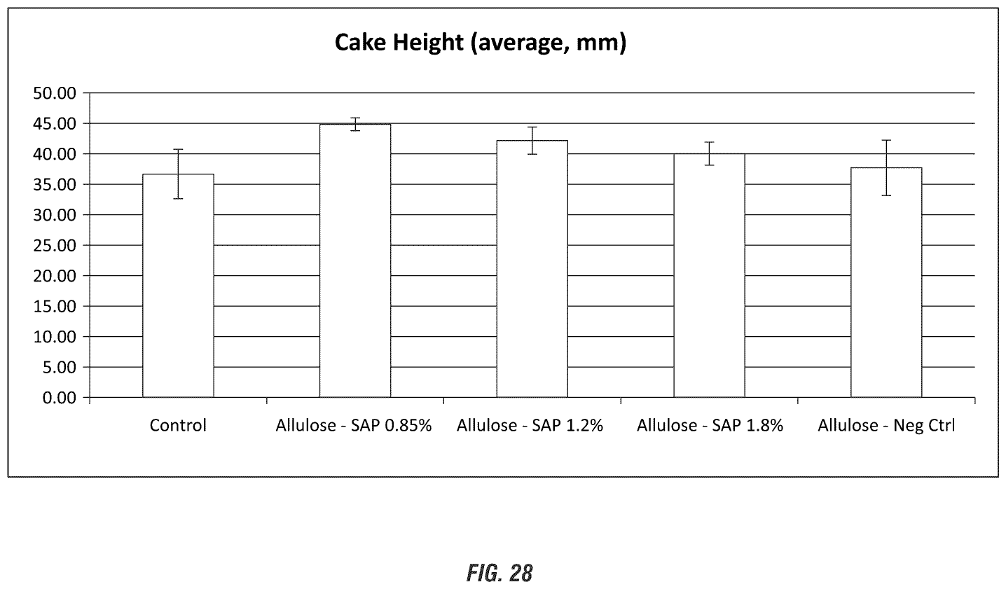

FIG. 28 shows the averages with standard deviation error bars for the data in Table 37, demonstrating that cakes made with sodium aluminum phosphate were generally higher in rise than control and negative control.

### Cake Moisture Levels

The moisture of the cakes was measured by cutting a slice of cake across the diameter and crumbing it, then measuring the moisture content as a percentage using a Sartorius MA35 Moisture Analyzer. Three replicates were performed for each sample. Table 38 shows the average moisture value for each cake.

TABLE 38
Cake Moisture (in Percent)

| Sample | Moisture % |
|---|---|
| Control | 31.85% |
| Allulose with 0.85% SAP | 29.95% |
| Allulose with 1.2% SAP | 29.97% |
| Allulose with 1.8% SAP | 30.48% |
| Allulose | 32.19% |

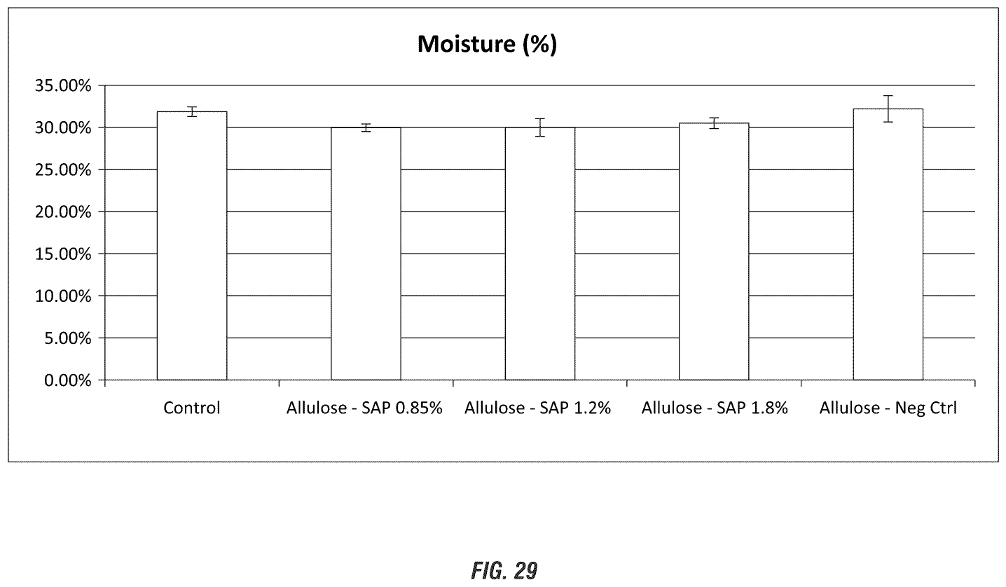

FIG. 29 shows graphically with standard deviation error bars the data of Table 38, demonstrating the cakes with sodium aluminum phosphate have a moisture content that is slightly lower than control.

### Water Activity of Cakes

The water activity of the cakes was measured by cutting a slice of cake across the diameter and crumbing it, then finding the water activity using a Rotronic Hygrolab v4_11 Benchtop Indicator. Table 39 shows the water activity for each cake.

TABLE 39
Cake Water Activity Values

| Sample | Water Activity |
|---|---|
| Control | 0.88 |
| Allulose with 0.85% SAP | 0.88 |
| Allulose with 1.2% SAP | 0.88 |
| Allulose with 1.8% SAP | 0.88 |
| Allulose | 0.89 |

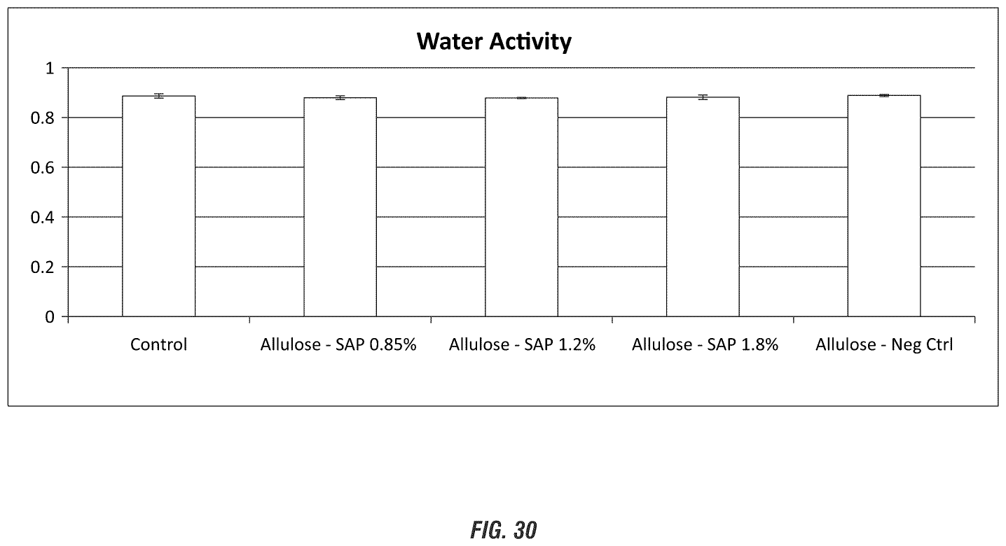

FIG. 30 shows graphically the data of Table 39, demonstrating the water activity is very comparable between control and all variables.

1. An allulose-containing baked good composition comprising:
(i) from about 1 wt-% to about 25 wt-% allulose (dry basis);
(ii) from about 0.3 wt-% to about 3 wt-% leavening acid, wherein the leavening acid is cream of tartar, citric acid, glucono delta-lactone, monocalcium phosphate, sodium acid pyrophosphate, sodium aluminum phosphate, or a mixture thereof;
(iii) a nutritive sweetener at least partially replaced by the allulose; and
(iv) a combination of at least three baking ingredients comprising flour, eggs and/or egg derived products, milk and/or other dairy or non-dairy products, oil and/or fats.

2. The composition according to claim 1, wherein the allulose is a liquid syrup comprising at least about 85% allulose and about 15% other monosaccharides and/or disaccharides, at least about 90% allulose and about 10% other monosaccharides and/or disaccharides, or at least about 95% allulose and about 5% other monosaccharides and/or disaccharides.

3. The composition according to claim 1, wherein the allulose comprises from about 2 wt-% to about 25 wt-%, from about 5 wt-% to about 15 wt-%, or about 10 wt-% to about 15 wt-% of the composition on a dry basis.

4. The composition according to claim 1, wherein the leavening acid is (i) cream of tartar and comprises from about 0.5 wt-% to about 2.5 wt-% of the composition, (ii) glucono delta-lactone and comprises from about 0.3 wt-% to about 1.8 wt-% or from about 0.85 wt-% to about 1.8 wt-% of the composition, (iii) citric acid and comprises from about 0.5 wt-% to about 2 wt-% of the composition; (iv) monocalcium phosphate and comprises from about 0.31 wt-% to about 0.85 wt-% of the composition; (v) sodium acid pyrophosphate and comprises from about 0.3 wt-% to about 1.8 wt-% of the composition; or (vi) sodium aluminum phosphate and comprises from about 0.3 wt-% to about 1.8 wt-% of the composition.

5. The composition according to claim 1, further comprises a leavening agent, wherein the leavening agent is baking soda in an amount of from about 0.5 wt-% to about 1.5 wt-% of the composition.

6. The composition according to claim 1, wherein the nutritive sweetener is sucrose.

7. The composition according to claim 1, wherein the baking ingredients comprise from about 30 wt-% to about 70 wt-% of the composition.

8. The composition according to claim 1, further comprising one or more additional baking ingredient selected from salt, water, other starchy ingredient, non-nutritive sweetener, partially-nutritive sweetener, alcohol, flavoring liquor, stabilizing agent, bulking agent, colorant, flavorant, spice, fruit, fruit-derived product, vegetable, vegetable-derived product, legume, legume-derived product, nut, nut-derived product, preservative, stabilizer, antioxidant, emulsifier, protein, amino acid, vitamin, and mineral.

9. The composition according to claim 1, wherein the composition has at least a 10% sugar reduction, 20% sugar reduction, 25% sugar reduction, 30% sugar reduction, 40% sugar reduction, 50% sugar reduction, 75% sugar reduction, or at least 100% sugar reduction in comparison to a full sugar baked good composition.

10. The composition according to claim 1, wherein the composition has at least a 1% calorie reduction, at least a 5% calorie reduction, at least a 10% calorie reduction, at least a 15% calorie reduction, at least a 20% calorie reduction, or at least a 25% calorie reduction in comparison to a full sugar baked good composition.

11. The composition according to claim 1, wherein the composition is a cake composition, cookie composition, roll composition, pie composition, pastry composition, tart composition, torte composition, sweet bread composition, sweet biscuit composition, or muffin composition.

12. The composition according to claim 1, wherein the composition is a cake composition.

13. An allulose-containing baked good comprising the composition according to claim 1, wherein the allulose-containing baked good has comparable browning to a full sugar baked good comprising a composition containing a nutritive sweetener as measured by (i) L color measurement having a “Delta L” with a minimum of −13, wherein “L” represents a change in color from black to white; (ii) “a” and/or “b” color measurements having at least one of a “Delta a” with a maximum of +6.5 and/or a “Delta b” with a maximum of +2.5, wherein the “Delta” measurement is the sample value minus a full sugar control value, and wherein “a” represents a change in color from green to red, and “b” represents a change in color from blue to yellow; or (iii) a combination of (i) and (ii).

14. (canceled)

15. A method for reducing the browning of an allulose-containing baked good comprising:
(i) replacing at least a portion of a nutritive sweetener in a baked good composition with allulose;
(ii) adding one or more leavening acid selected from cream of tartar, citric acid, glucono delta-lactone, monocalcium phosphate, sodium acid pyrophosphate, and sodium aluminum phosphate to the composition;
(iii) baking the composition; and
(iv) obtaining the allulose-containing baked good.

16. The method according to claim 15, wherein the allulose-containing baked good has comparable browning to a full sugar baked good comprising a composition containing a nutritive sweetener as measured by (i) L color measurement having a “Delta L” with a minimum of −13, wherein “L” represents a change in color from black to white; (ii) “a” and/or “b” color measurements having at least one of a “Delta a” with a maximum of +6.5 and/or a “Delta b” with a maximum of +2.5, wherein the “Delta” measurement is the sample value minus a full sugar control value, and wherein “a” represents a change in color from green to red, and “b” represents a change in color from blue to yellow; or (iii) a combination of (i) and (ii).

17. The method according to claim 15, wherein the allulose-containing baked good is a cake, cookie, roll, pie, pastry, tart, torte, sweet bread, sweet biscuit, or muffin.

18. The method according to claim 15, wherein the allulose-containing baked good is a cake.

19. A food ingredient system comprising allulose and one or more leavening acid selected from cream of tartar, citric acid, and glucono delta-lactone.

20. The system according to claim 19, further comprising a nutritive, partially-nutritive and/or non-nutritive sweetener, and, optionally, baking soda.
